(19) United States
(12) Patent Application Publication
(10) Pub. No.: US 2024/0430873 A1
(43) Pub. Date: Dec. 26, 2024

(54) RADIO RESOURCE OPERATING METHOD AND APPARATUS IN NON-TERRESTRIAL NETWORK

(71) Applicants: HYUNDAI MOTOR COMPANY, Seoul (KR); KIA CORPORATION, Seoul (KR); INHA UNIVERSITY RESEARCH AND BUSINESS FOUNDATION, Incheon (KR)

(72) Inventors: Young Kil Suh, Hwaseong-si (KR); Ui Hyun Hong, Hwaseong-si (KR); Duk Kyung Kim, Hwaseong-si (KR)

(73) Assignees: HYUNDAI MOTOR COMPANY, Seoul (KR); KIA CORPORATION, Seoul (KR); INHA University Research and Business Foundation, Incheon (KR)

(21) Appl. No.: 18/813,535

(22) Filed: Aug. 23, 2024

Related U.S. Application Data
(63) Continuation-in-part of application No. PCT/KR2023/003127, filed on Mar. 7, 2023.

(30) Foreign Application Priority Data
Mar. 7, 2022 (KR) 10-2022-0028997

(51) Int. Cl. H04W 72/0457; H04B 7/06; H04B 7/10; H04W 24/10

(52) U.S. Cl. CPC H04W 72/0457; H04B 7/0695; H04B 7/10; H04W 24/10

(57) ABSTRACT

A first communication node may include the steps of: performing communication with a second communication node using a first beam from among multi-beams formed by the second communication node, on the basis of a first polarized wave and one or more first BWPs allocated by the second communication node; generating a measurement report including a measurement value for at least the first beam; transmitting the generated measurement report to the second communication node; receiving, from the second communication node, BWP configuration change information generated on the basis of beam switching determination based on the measurement report; and performing communication with the second communication node using a second beam from among the multi-beams, on the basis of information of a second polarized wave and information of one or more second BWPs identified on the basis of the BWP configuration change information.

### CROSS-REFERENCE TO RELATED APPLICATION

The present application is a continuation-in-part of currently pending International Patent Application No. PCT/KR2023/003127, filed Mar. 7, 2023, which claims priority to Korean Patent Application Number 10-2022-0028997 filed Mar. 7, 2022, the entire contents of which are incorporated herein for all purposes by these references.

### BACKGROUND OF THE PRESENT DISCLOSURE

### Field of the Present Disclosure

The present disclosure relates to a radio resource operation technique in a non-terrestrial network, and more particularly, to a radio resource operation technique for enhancing efficiency of beam switching in a non-terrestrial network utilizing multiple beams.

### Description of Related Art

A communication network (e.g., 5G communication network, 6G communication network, etc.) to provide enhanced communication services compared to the existing communication network (e.g., Long Term Evolution (LTE), LTE-Advanced (LTA-A), etc.) is being developed. The 5G communication network (e.g., new radio (NR) communication network) can support not only a frequency band of 6 GHz or below, but also a frequency band of 6 GHz or above. That is, the 5G communication network can support a frequency range (FR1) band and/or FR2 band. The 5G communication network can support various communication services and scenarios compared to the LTE communication network. For example, usage scenarios of the 5G communication network may include enhanced Mobile BroadBand (eMBB), Ultra Reliable Low Latency Communication (URLLC), Massive Machine Type Communication (mMTC), and the like.

The 6G communication network can support a variety of communication services and scenarios compared to the 5G communication network. The 6G communication networks can meet the requirements of hyper-performance, hyper-bandwidth, hyper-space, hyper-precision, hyper-intelligence, and/or hyper-reliability. The 6G communication networks can support various and wide frequency bands and can be applied to various usage scenarios (e.g. terrestrial communication, non-terrestrial communication, sidelink communication, and the like).

The communication network (e.g. 5G communication network, 6G communication network, etc.) may provide communication services to terminals located on the ground. Recently, the demand for communication services for not only terrestrial but also non-terrestrial airplanes, drones, and satellites has been increasing, and for this purpose, technologies for a non-terrestrial network (NTN) have been discussed. The non-terrestrial network may be implemented based on 5G communication technology, 6G communication technology, and/or the like. For example, in the non-terrestrial network, communication between a satellite and a terrestrial communication node or a non-terrestrial communication node (e.g. airplane, drone, or the like) may be performed based on 5G communication technology, 6G communication technology, and/or the like. In the NTN, the satellite may perform functions of a base station in a communication network (e.g. 5G communication network, 6G communication network, and/or the like).

In an NTN environment using multiple beams, continuous beam switching may occur due to satellite or terminal movements. Especially when the value of the Frequency Reuse Factor (FRF) (or Frequency Reuse/Polarization Factor (FRPF)) exceeds 1, frequency and/or polarization configurations may need to be changed during beam switching according to the value of FRF (or FRPF). Consequently, the configuration of Bandwidth Parts (BWPs) allocated to each terminal may need to be adjusted each time beam switching occurs. In particular, for satellites using Earth-Fixed Beam (EFB) service links or Earth-Fixed Beams, rapid BWP configuration changes may be required for terminals serviced by the respective beams during beam switching. As a result, the signaling complexity for BWP configuration changes may increase. Radio resource management techniques may be necessary to enhance the efficiency of beam switching in the NTN when the value of FRF (or FRPF) exceeds 1.

The information disclosed in this Background of the Invention section is only for enhancement of understanding of the general background of the invention and may not be taken as an acknowledgement or any form of suggestion that this information forms the related art already known to a person skilled in the art.

### BRIEF SUMMARY

Various aspects of the present disclosure are directed to providing a method and an apparatus for enhancing efficiency of beams switching in a non-terrestrial network.

An exemplary embodiment of an operation method of a first communication node for achieving the above-described objective may include: performing communication with a second communication node using a first beam among multiple beams formed by the second communication node, based on one or more first bandwidth parts (BWPs) allocated by the second communication node and a first polarization; generating a measurement report including at least a measurement value for the first beam; transmitting the generated measurement report to the second communication node; receiving, from the second communication node, BWP configuration change information generated based on a beam switching decision performed at the second communication node based on the measurement report; and performing communication with the second communication node using a second beam among the multiple beams, based on information on one or more second BWPs and a second polarization identified based on the BWP configuration change information, wherein frequency-domain positions of paired BWPs of each BWP pair between the one or more first BWPs and the one or more second BWPs may have a difference of Δf, and Δf is a real number identified based on the BWP configuration change information.

A first resource configuration may be applied to the first beam, a second resource configuration different from the first resource configuration may be applied to the second beam, and each of the first and second resource configurations may be defined based on information on a frequency bandwidth available for an applicable beam to which each of the first and second resource configurations is applied and information on a polarization applied to the applicable beam.

One of the first to N-th resource configurations may be applied to each of the multiple beams, the first to N-th resource configurations may be different from each other, and N may be a natural number determined based on a number of types of polarizations applicable to the multiple beams, including the first and second polarizations.

The first resource configuration may correspond to a first frequency bandwidth and the first polarization, the second resource configuration may correspond to a second frequency bandwidth and the second polarization, and frequency-domain positions of the first frequency bandwidth and the second frequency bandwidth may have a difference equal to Δf.

When the first frequency bandwidth corresponding to the first resource configuration and the second frequency bandwidth corresponding to the second resource configuration are equal, and frequency-domain positions of paired BWPs of each BWP pair between the one or more first BWPs and the one or more second BWPs may be identical.

The BWP configuration change information may include a polarization change indicator determined based on information on the second polarization.

The polarization change indicator may indicate whether to change polarization and may be determined based on comparison between the first polarization and the second polarization.

An exemplary embodiment of an operation method of a first communication node for achieving the above-described objective may include: performing communication with a second communication node using a first beam among multiple beams formed by the first communication node, based on one or more first bandwidth parts (BWPs) allocated to the second communication node and a first polarization; receiving a measurement report from the second communication node including at least a measurement value for the first beam; in response to determining beam switching from the first beam to a second beam among the multiple beams based on the measurement report, generating BWP configuration change information including information related to one or more second BWPs corresponding to the second beam and a second polarization; transmitting the BWP configuration change information to the second communication node; and performing communication with the second communication node using the second beam, based on the one or more second BWPs and the second polarization, wherein frequency-domain positions of paired BWPs of each BWP pair between the one or more first BWPs and the one or more second BWPs may have a difference of Δf, and Δf is a real number identified based on the BWP configuration change information.

A first resource configuration may be applied to the first beam, a second resource configuration different from the first resource configuration may be applied to the second beam, and each of the first and second resource configurations may be defined based on information on a frequency bandwidth available for an applicable beam to which each of the first and second resource configurations is applied and information on a polarization applied to the applicable beam.

The first resource configuration may correspond to a first frequency bandwidth and the first polarization, the second resource configuration may correspond to a second frequency bandwidth and the second polarization, and frequency-domain positions of the first frequency bandwidth and the second frequency bandwidth may have a difference equal to Δf.

The BWP configuration change information may include a polarization change indicator determined based on information on the second polarization.

The polarization change indicator may indicate whether to change polarization and may be determined based on comparison between the first polarization and the second polarization.

An exemplary embodiment of a first communication node for achieving the above-described objective may include a processor, and the processor causes the first communication node to perform: performing communication with a second communication node using a first beam among multiple beams formed by the second communication node, based on one or more first bandwidth parts (BWPs) allocated by the second communication node and a first polarization; generating a measurement report including at least a measurement value for the first beam; transmitting the generated measurement report to the second communication node; receiving, from the second communication node, BWP configuration change information generated based on a beam switching decision performed at the second communication node based on the measurement report; and performing communication with the second communication node using a second beam among the multiple beams, based on information on one or more second BWPs and a second polarization identified based on the BWP configuration change information, wherein frequency-domain positions of paired BWPs of each BWP pair between the one or more first BWPs and the one or more second BWPs may have a difference of Δf, and Δf is a real number identified based on the BWP configuration change information.

A first resource configuration may be applied to the first beam, a second resource configuration different from the first resource configuration may be applied to the second beam, and each of the first and second resource configurations may be defined based on information on a frequency bandwidth available for an applicable beam to which each of the first and second resource configurations is applied and information on a polarization applied to the applicable beam.

One of the first to N-th resource configurations may be applied to each of the multiple beams, the first to N-th resource configurations may be different from each other, and N may be a natural number determined based on a value of a frequency reuse factor (FRF).

The first resource configuration may correspond to a first frequency bandwidth and the first polarization, the second resource configuration may correspond to a second frequency bandwidth and the second polarization, and frequency-domain positions of the first frequency bandwidth and the second frequency bandwidth may have a difference equal to Δf.

According to exemplary embodiments of a method and apparatus for radio resource management in the NTN, a terminal connected to the NTN may change its BWP configuration based on BWP configuration change information received from a network entity, such as a satellite. The BWP configuration change information may include frequency change information and/or polarization change information. Therefore, even when the value of the Frequency Reuse Factor (FRF) or the Frequency Reuse/Polarization Factor (FRPF), defined based on the FRF and the number of applicable polarization types, exceeds 1, beam switching can be accomplished with low signaling complexity.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1A is a conceptual diagram illustrating various exemplary embodiments of a non-terrestrial network.

FIG. 1B is a conceptual diagram illustrating various exemplary embodiments of a non-terrestrial network.

FIG. 2A is a conceptual diagram illustrating various exemplary embodiments of a non-terrestrial network.

FIG. 2B is a conceptual diagram illustrating various exemplary embodiments of a non-terrestrial network.

FIG. 2C is a conceptual diagram illustrating various exemplary embodiments of a non-terrestrial network.

FIG. 3 is a block diagram illustrating various exemplary embodiments of a communication node constituting a non-terrestrial network.

FIG. 4 is a block diagram illustrating various exemplary embodiments of communication nodes performing communication.

FIG. 5A is a block diagram illustrating various exemplary embodiments of a transmission path.

FIG. 5B is a block diagram illustrating various exemplary embodiments of a reception path.

FIG. 6A is a conceptual diagram illustrating various exemplary embodiments of a protocol stack of a user plane in a transparent payload-based non-terrestrial network.

FIG. 6B is a conceptual diagram illustrating various exemplary embodiments of a protocol stack of a control plane in a transparent payload-based non-terrestrial network.

FIG. 7A is a conceptual diagram illustrating various exemplary embodiments of a protocol stack of a user plane in a regenerative payload-based non-terrestrial network.

FIG. 7B is a conceptual diagram illustrating various exemplary embodiments of a protocol stack of a control plane in a regenerative payload-based non-terrestrial network.

FIG. 8 is a conceptual diagram illustrating an exemplary embodiment of a communication system to which a frequency reuse technique is applied.

FIG. 9 is a conceptual diagram illustrating exemplary embodiments of radio resource operation schemes in the communication system to which the frequency reuse technique is applied.

FIG. 10A and FIG. 10B are conceptual diagrams illustrating exemplary embodiments of a BWP operation method in a communication system.

FIG. 11A, FIG. 11B, and FIG. 11C are conceptual diagrams illustrating exemplary embodiments of BWP configuration scenarios in a communication system.

FIG. 12A and FIG. 12B are conceptual diagrams illustrating various exemplary embodiments of a radio resource operation method in a communication system.

FIGS. 13A and 13B are conceptual diagrams illustrating various exemplary embodiments of a radio resource operation method in a communication system.

FIG. 14 is a flowchart for describing the first and various exemplary embodiments of the radio resource operation method in the communication system.

It may be understood that the appended drawings are not necessarily to scale, presenting a somewhat simplified representation of various features illustrative of the basic principles of the present disclosure. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments of the present disclosure, it will be understood that the present description is not intended to limit the invention(s) to those exemplary embodiments. On the contrary, the invention(s) is/are intended to cover not only the exemplary embodiments of the present disclosure, but also various alternatives, modifications, equivalents and other embodiments, which may be included within the spirit and scope of the invention as defined by the appended claims.

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In the present disclosure, “(re)transmission” may refer to “transmission”, “retransmission”, or “transmission and retransmission”, “(re)configuration” may refer to “configuration”, “reconfiguration”, or “configuration and reconfiguration”, “(re)connection” may refer to “connection”, “reconnection”, or “connection and reconnection”, and “(re)access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the present disclosure. As used herein, the singular forms are intended to include the plural forms as well, unless the context clearly indicates otherwise. It will be further understood that the terms “comprise” and/or “include” when used herein, specify the presence of stated features, integers, steps, operations, elements, components or combinations thereof, but do not preclude the presence or addition of one or more other features, integers, steps, operations, elements, components, and/or combinations thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted. In addition to the exemplary embodiments explicitly described in the present disclosure, operations may be performed according to a combination of the exemplary embodiments, extensions of the exemplary embodiments, and/or modifications of the exemplary embodiments. Performance of some operations may be omitted, and the order of performance of operations may be changed.

Even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a user equipment (UE) is described, a base station corresponding to the UE may perform an operation corresponding to the operation of the UE. Conversely, when an operation of a base station is described, a UE corresponding to the base station may perform an operation corresponding to the operation of the base station. In a non-terrestrial network (NTN) (e.g. payload-based NTN), operations of a base station may refer to operations of a satellite, and operations of a satellite may refer to operations of a base station.

The base station may refer to a NodeB, evolved NodeB (eNodeB), next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and/or the like. The UE may refer to a terminal, device, apparatus, node, communication node, end node, access terminal, mobile terminal, station, subscriber station, mobile station, portable subscriber station, on-broad unit (OBU), and/or the like.

In the present disclosure, signaling may be at least one of higher layer signaling, medium access control (MAC) signaling, or physical (PHY) signaling. Messages used for higher layer signaling may be referred to as ‘higher layer messages’ or ‘higher layer signaling messages’. Messages used for MAC signaling may be referred to as ‘MAC messages’ or ‘MAC signaling messages’. Messages used for PHY signaling may be referred to as ‘PHY messages’ or ‘PHY signaling messages’. The higher layer signaling may refer to a transmission and reception operation of system information (e.g. master information block (MIB), system information block (SIB)) and/or RRC messages. The MAC signaling may refer to a transmission and reception operation of a MAC control element (CE). The PHY signaling may refer to a transmission and reception operation of control information (e.g. downlink control information (DCI), uplink control information (UCI), and sidelink control information (SCI)).

In the present disclosure, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. In the present disclosure, “signal and/or channel” may mean a signal, a channel, or “signal and channel,” and “signal” may be used to mean “signal and/or channel”.

A communication system may include at least one of a terrestrial network, non-terrestrial network, 4G communication network (e.g. long-term evolution (LTE) communication network), 5G communication network (e.g. new radio (NR) communication network), or 6G communication network. Each of the 4G communications network, 5G communications network, and 6G communications network may include a terrestrial network and/or a non-terrestrial network. The non-terrestrial network may operate based on at least one communication technology among the LTE communication technology, 5G communication technology, or 6G communication technology. The non-terrestrial network may provide communication services in various frequency bands.

The communication network to which exemplary embodiments are applied is not limited to the content described below, and the exemplary embodiments may be applied to various communication networks (e.g. 4G communication network, 5G communication network, and/or 6G communication network). Here, a communication network may be used in the same sense as a communication system.

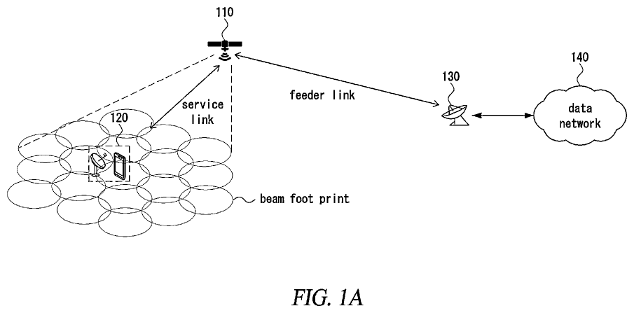

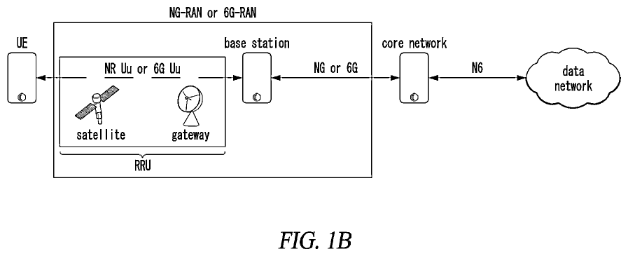

FIG. 1A is a conceptual diagram illustrating a first exemplary embodiment of a non-terrestrial network.

As shown in FIG. 1A, a non-terrestrial network (NTN) may include a satellite 110, a communication node 120, a gateway 130, a data network 140, and the like. A unit including the satellite 110 and the gateway 130 may correspond to a remote radio unit (RRU). The NTN shown in FIG. 1A may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS). A non-GEO satellite may be an LEO satellite and/or MEO satellite.

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may be referred to as an NTN payload. The gateway 130 may support a plurality of NTN payloads. The satellite 110 may provide communication services to the communication node 120 using one or more beams. The shape of a footprint of the beam of the satellite 110 may be elliptical or circular.

In the non-terrestrial network, three types of service links can be supported as follows.

Earth-fixed: a service link may be provided by beam(s) that continuously cover the same geographic area at all times (e.g. geosynchronous orbit (GSO) satellite).

Quasi-earth-fixed: a service link may be provided by beam(s) covering one geographical area during a limited period and provided by beam(s) covering another geographical area during another period (e.g. non-GSO (NGSO) satellite forming steerable beams).

Earth-moving: a service link may be provided by beam(s) moving over the Earth's surface (e.g. NGSO satellite forming fixed beams or non-steerable beams).

The communication node 120 may perform communications (e.g. downlink communication and uplink communication) with the satellite 110 using 4G communication technology, 5G communication technology, and/or 6G communication technology. The communications between the satellite 110 and the communication node 120 may be performed using an NR-Uu interface and/or 6G-Uu interface. When dual connectivity (DC) is supported, the communication node 120 may be connected to other base stations (e.g. base stations supporting 4G, 5G, and/or 6G functionality) as well as the satellite 110, and perform DC operations based on the techniques defined in 4G, 5G, and/or 6G technical specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface, a 6G-Uu interface, or a satellite radio interface (SRI). The gateway 130 may be connected to the data network 140. There may be a ‘core network’ between the gateway 130 and the data network 140. In the instant case, the gateway 130 may be connected to the core network, and the core network may be connected to the data network 140. The core network may support the 4G communication technology, 5G communication technology, and/or 6G communication technology. For example, the core network may include an access and mobility management function (AMF), a user plane function (UPF), a session management function (SMF), and the like. The communications between the gateway 130 and the core network may be performed based on an NG-C/U interface or 6G-C/U interface.

As shown in an exemplary embodiment of FIG. 1B, there may be a ‘core network’ between the gateway 130 and the data network 140 in a transparent payload-based NTN.

FIG. 1B is a conceptual diagram illustrating a second exemplary embodiment of a non-terrestrial network.

As shown in FIG. 1B, the gateway may be connected with the base station, the base station may be connected with the core network, and the core network may be connected with the data network. Each of the base station and core network may support the 4G communication technology, 5G communication technology, and/or 6G communication technology. The communications between the gateway and the base station may be performed based on an NR-Uu interface or 6G-Uu interface, and the communications between the base station and the core network (e.g. AMF, UPF, SMF, and the like) may be performed based on an NG-C/U interface or 6G-C/U interface.

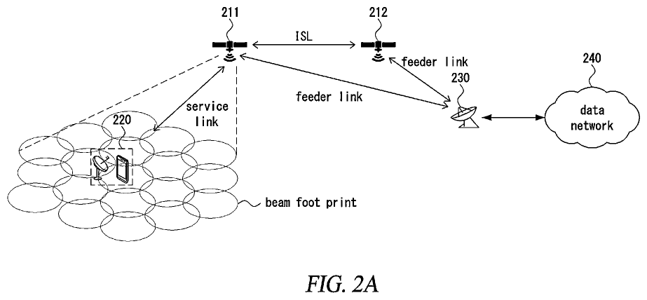

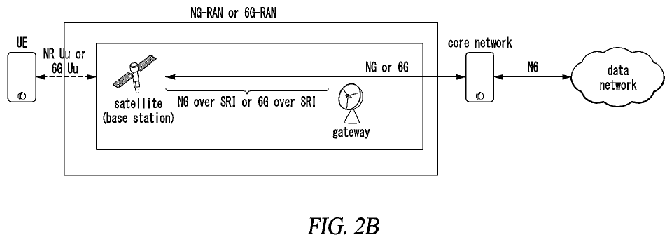

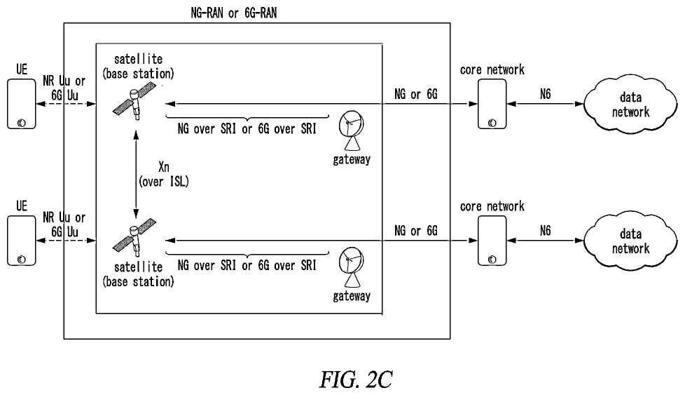

FIG. 2A is a conceptual diagram illustrating a third exemplary embodiment of a non-terrestrial network.

As shown in FIG. 2A, a non-terrestrial network may include a first satellite 211, a second satellite 212, a communication node 220, a gateway 230, a data network 240, and the like. The NTN shown in FIG. 2A may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may be referred to as an NTN payload. The satellite 211 may provide communication services to the communication node 220 using one or more beams.

The communication node 220 may perform communications (e.g. downlink communication or uplink communication) with the satellite 211 using the 4G communication technology, 5G communication technology, and/or 6G communication technology. The communications between the satellite 211 and the communication node 220 may be performed using an NR-Uu interface or 6G-Uu interface. When DC is supported, the communication node 220 may be connected to other base stations (e.g. base stations supporting 4G, 5G, and/or 6G functionality) as well as the satellite 211, and may perform DC operations based on the techniques defined in 4G, 5G, and/or 6G technical specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily. The communications between each of the satellites 211 and 212 and the gateway 230 may be performed based on an NR-Uu interface, a 6G-Uu interface, or an SRI. The gateway 230 may be connected to the data network 240.

As shown in exemplary embodiments of FIG. 2B and FIG. 2C, there may be a ‘core network’ between the gateway 230 and the data network 240.

FIG. 2B is a conceptual diagram illustrating a fourth exemplary embodiment of a non-terrestrial network, and FIG. 2C is a conceptual diagram illustrating a fifth exemplary embodiment of a non-terrestrial network.

As shown in FIG. 2B and FIG. 2C, the gateway may be connected with the core network, and the core network may be connected with the data network. The core network may support the 4G communication technology, 5G communication technology, and/or 6G communication technology. For example. The core network may include AMF, UPF, SMF, and the like. Communication between the gateway and the core network may be performed based on an NG-C/U interface or 6G-C/U interface. Functions of a base station may be performed by the satellite. That is, the base station may be located on the satellite. The base station located on the satellite may be a base station-distributed unit (DU), and a base station-centralized unit (CU) may be located within NG-RAN or 6G-RAN. A payload may be processed by the base station located on the satellite. Base stations located on different satellites may be connected to the same core network. One satellite may have one or more base stations. In the non-terrestrial network of FIG. 2B, an ISL between satellites may not be established, and in the non-terrestrial network of FIG. 2C, an ISL between satellites may be established.

Meanwhile, the entities (e.g. satellite, base station, UE, communication node, gateway, and the like) constituting the non-terrestrial network shown in FIGS. 1A, 1B, 2A, 2B, and/or 2C may be configured as follows. In the present disclosure, the entity may be referred to as a communication node.

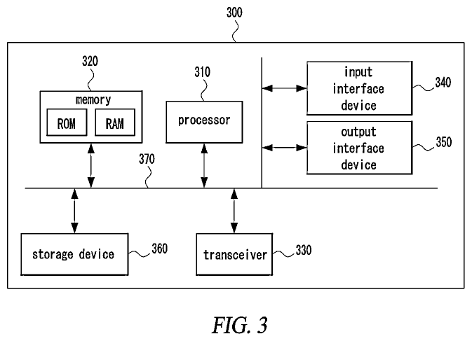

FIG. 3 is a block diagram illustrating a first exemplary embodiment of a communication node constituting a non-terrestrial network.

As shown in FIG. 3, a communication node 300 may include at least one processor 310, a memory 320, and a transceiver 330 connected to a network to perform communication. In addition, the communication node 300 may further include an input interface device 340, an output interface device 350, a storage device 360, and the like. The components included in the communication node 300 may be connected by a bus 370 to communicate with each other.

However, each component included in the communication node 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

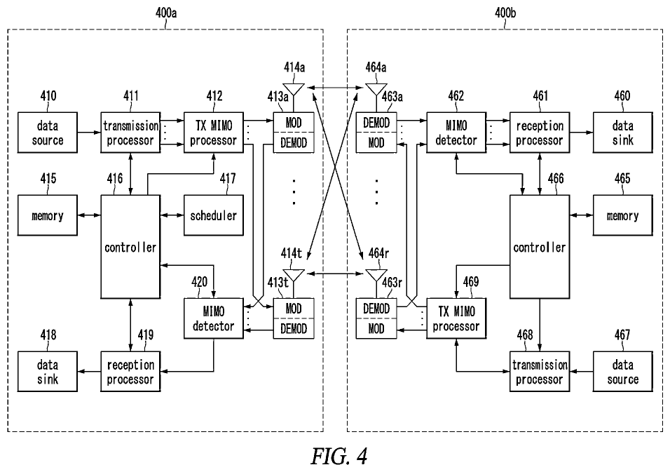

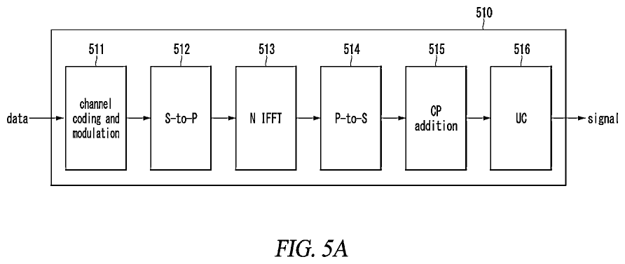

Meanwhile, communication nodes that perform communications in the communication network (e.g. non-terrestrial network) may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g. data unit) from a data source 410. The transmission processor 411 may receive control information from a controller 416. The control information may include at least one of system information, RRC configuration information (e.g. information configured by RRC signaling), MAC control information (e.g. MAC CE), or PHY control information (e.g. DCI, SCI).

The transmission processor 411 may generate data symbol(s) by performing processing operations (e.g. encoding operation, symbol mapping operation, etc.) on the data. The transmission processor 411 may generate control symbol(s) by performing processing operations (e.g. encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g. precoding operations) on the data symbol(s), control symbol(s), and/or synchronization/reference symbol(s). An output (e.g. symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g. analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g. filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g. de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g. data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g. precoding operations) on the data symbol(s), control symbol(s), and/or reference symbol(s). An output (e.g. symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g. analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g. filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g. de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

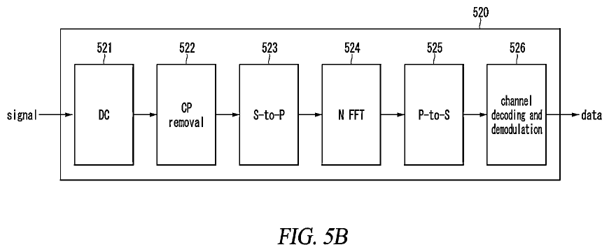

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse Fast Fourier Transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g. low-density parity check (LDPC) coding operation, polar coding operation, etc.) and a modulation operation (e.g. Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g. components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, NTN reference scenarios may be defined as shown in Table 1 below.

TABLE 1

| | NTN shown in FIG. 1 | NTN shown in FIG. 2 |
|---|---|---|
| GEO | Scenario A | Scenario B |
| LEO (steerable | Scenario C1 | Scenario D1 |
| beams) | | |
| LEO (beams | Scenario C2 | Scenario D2 |
| moving with | | |
| satellite) | | |

When the satellite 110 in the NTN shown in FIG. 1A and/or FIG. 1B is a GEO satellite (e.g. a GEO satellite that supports a transparent function), this may be referred to as ‘scenario A’. When the satellites 211 and 212 in the NTN shown in FIG. 2A, FIG. 2B, and/or FIG. 2C are GEO satellites (e.g. GEOs that support a regenerative function), this may be referred to as ‘scenario B’.

When the satellite 110 in the NTN shown in FIG. 1A and/or FIG. 1B is an LEO satellite with steerable beams, this may be referred to as ‘scenario C1’. When the satellite 110 in the NTN shown in FIG. 1A and/or FIG. 1B is an LEO satellite having beams moving with the satellite, this may be referred to as ‘scenario C2’. When the satellites 211 and 212 in the NTN shown in FIG. 2A, FIG. 2B, and/or FIG. 2C are LEO satellites with steerable beams, this may be referred to as ‘scenario D1’. When the satellites 211 and 212 in the NTN shown in FIG. 2A, FIG. 2B, and/or FIG. 2C are LEO satellites having beams moving with the satellites, this may be referred to as ‘scenario D2’.

Parameters for the NTN reference scenarios defined in Table 1 may be defined as shown in Table 2 below.

TABLE 2

| | |
|---|---|
| Scenarios A | Scenarios C |
| and B | and D |

| Altitude | 35,786 | km | 600 km |
|---|---|---|---|
| | | | 1,200 km |
| Spectrum (service | <6 GHz (e.g. 2 GHz) | | |
| link) | >6 GHz (e.g. DL 20 GHz, UL 30 GHz) | | |
| Maximum channel | 30 MHz for band <6 GHz | | |
| bandwidth capability | 1 GHz for band >6 GHz | | |
| (service link) | | | |
| Maximum distance | 40,581 | km | 1,932 km (altitude |
| between satellite and | | | of 600 km) |
| communication node (e.g. | | | 3,131 km (altitude |
| UE) at the minimum | | | of 1,200 km) |
| elevation angle | | | |

| | | |
|---|---|---|
| Maximum round | Scenario A: | Scenario C: |
| trip delay (RTD) | 541.46 ms (service and | (transparent payload: |
| (only propagation | feeder links) | service and feeder links) |
| delay) | Scenario B: | −5.77 ms (altitude |
| | 270.73 ms (only | of 60 0 km) |
| | service link) | −41.77 ms (altitude |

| | | | |
|---|---|---|---|
| | | | of 1,200 km) |
| | | | Scenario D: |
| | | | (regenerative payload: |
| | | | only service link) |
| | | | −12.89 ms (altitude |
| | | | of 600 km) |
| | | | −20.89 ms (altitude |
| | | | of 1,200 km) |
| Maximum | 10.3 | ms | 3.12 ms (altitude |
| differential delay | | | of 600 km) |
| within a cell | | | 3.18 ms (altitude |
| | | | of 1,200 km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | | | Scenario C1- | | Scenario D1- | |
|---|---|---|---|---|---|---|
| | Scenario A | Scenario B | 2 | | 2 | |
| Satellite altitude | 35,786 km | | 600 km | | | |
| Maximum RTD in a | 541.75 ms | 270.57 ms | 28.41 | ms | 12.88 | ms |
| radio interface | (worst case) | | | | | |
| between base station | | | | | | |
| and UE | | | | | | |
| Minimum RTD in a | 477.14 ms | 238.57 ms | 8 | ms | 4 | ms |
| radio interface | | | | | | |
| between base station | | | | | | |
| and UE | | | | | | |

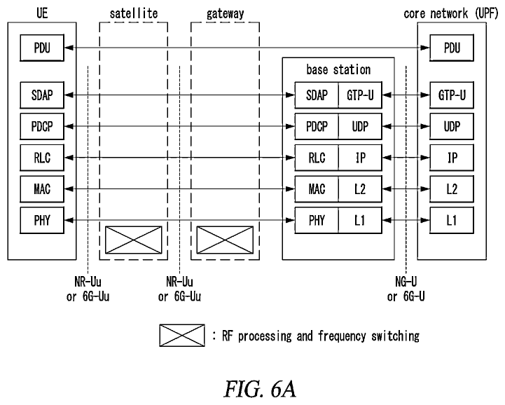

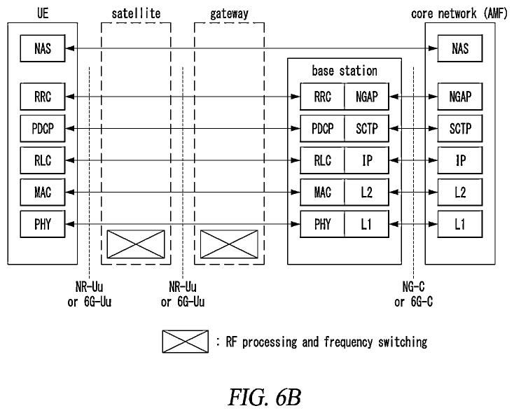

FIG. 6A is a conceptual diagram illustrating a first exemplary embodiment of a protocol stack of a user plane in a transparent payload-based non-terrestrial network, and FIG. 6B is a conceptual diagram illustrating a first exemplary embodiment of a protocol stack of a control plane in a transparent payload-based non-terrestrial network.

As shown in FIGS. 6A and 6B, user data may be transmitted and received between a UE and a core network (e.g. UPF), and control data (e.g. control information) may be transmitted and received between the UE and the core network (e.g. AMF). Each of the user data the and control data may be transmitted and received through a satellite and/or gateway. The protocol stack of the user plane shown in FIG. 6A may be applied identically or similarly to a 6G communication network. The protocol stack of the control plane shown in FIG. 6B may be applied identically or similarly to a 6G communication network.

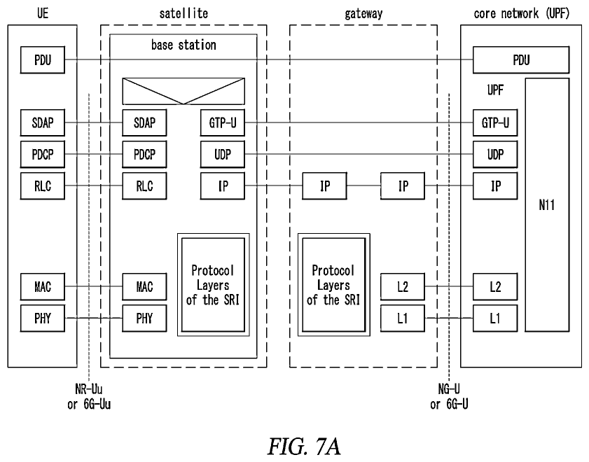

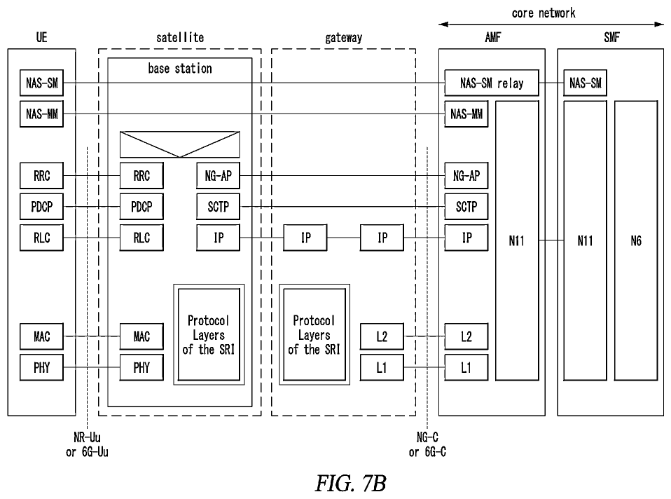

FIG. 7A is a conceptual diagram illustrating a first exemplary embodiment of a protocol stack of a user plane in a regenerative payload-based non-terrestrial network, and FIG. 7B is a conceptual diagram illustrating a first exemplary embodiment of a protocol stack of a control plane in a regenerative payload-based non-terrestrial network.

As shown in FIGS. 7A and 7B, each of user data and control data (e.g. control information) may be transmitted and received through an interface between a UE and a satellite (e.g. base station). The user data may refer to a user protocol data unit (PDU). A protocol stack of a satellite radio interface (SRI) may be used to transmit and receive the user data and/or control data between the satellite and a gateway. The user data may be transmitted and received through a general packet radio service (GPRS) tunneling protocol (GTP)-U tunnel between the satellite and a core network.

Meanwhile, in a non-terrestrial network, a base station may transmit system information (e.g. SIB19) including satellite assistance information for NTN access. A UE may receive the system information (e.g. SIB19) from the base station, identify the satellite assistance information included in the system information, and perform communication (e.g. non-terrestrial communication) based on the satellite assistance information. The SIB19 may include information element(s) defined in Table 4 below.

TABLE 4
SIB19-r17 ::= SEQUENCE {

| | |
|---|---|
| ntn-Config-r17 | NTN-Config-r17 |
| t-Service-r17 | INTEGER(0..549755813887) |
| referenceLocation-r17 | ReferenceLocation-r17 |
| distanceThresh-r17 | INTEGER(0..65525) |
| ntn-NeighCellConfigList-r17 | NTN-NeighCellConfigList-r17 |
| lateNonCriticalExtension | OCTET STRING |

```
  ...,
  [[
```

| | |
|---|---|
| ntn-NeighCellConfigListExt-v1720 | NTN-NeighCellConfigList-r17 |

]]
}

| | |
|---|---|
| NTN-NeighCellConfigList-r17 ::= | SEQUENCE |

(SIZE(1..maxCellNTN-r17)) OF NTN-NeighCellConfig-r17

| | |
|---|---|
| NTN-NeighCellConfig-r17 ::= | SEQUENCE { |
| ntn-Config-r17 | NTN-Config-r17 |
| carrierFreq-r17 | ARFCN-ValueNR |
| physCellId-r17 | PhysCellId |

}

NTN-Config defined in Table 4 may include information element(s) defined in Table 5 below.

TABLE 5

| | |
|---|---|
| NTN-Config-r17 ::= | SEQUENCE { |
| epochTime-r17 | EpochTime-r17 |

ntn-UlSyncValidityDuration-r17 ENUMERATED{ s5, s10, s15, s20,
s25, s30, s35, s40, s45, s50, s55, s60, s120, s180, s240, s900}

| | |
|---|---|
| cellSpecificKoffset-r17 | INTEGER(1..1023) |
| kmac-r17 | INTEGER(1..512) |
| ta-Info-r17 | TA-Info-r17 |
| ntn-PolarizationDL-r17 | ENUMERATED {rhcp,lhcp,linear} |
| ntn-PolarizationUL-r17 | ENUMERATED {rhcp,lhcp,linear} |
| ephemerisInfo-r17 | EphemerisInfo-r17 |
| ta-Report-r17 | ENUMERATED {enabled} |

...
}

| | |
|---|---|
| EpochTime-r17 ::= | SEQUENCE { |
| sfn-r17 | INTEGER(0..1023), |
| subFrameNR-r17 | INTEGER(0..9) |

}

| | |
|---|---|
| TA-Info-r17 ::= | SEQUENCE { |
| ta-Common-r17 | INTEGER(0..66485757), |
| ta-CommonDrift-r17 | INTEGER(−257303..257303) |
| ta-CommonDriftVariant-r17 | INTEGER(0..28949) |

}

EphemerisInfo defined in Table 5 may include information element(s) defined in Table 6 below.

TABLE 6

| | |
|---|---|
| EphemerisInfo-r17 ::= | CHOICE { |
| positionVelocity-r17 | PositionVelocity-r17, |
| orbital-r17 | Orbital-r17 |

}

| | |
|---|---|
| PositionVelocity-r17 ::= | SEQUENCE { |
| positionX-r17 | PositionStateVector-r17, |
| positionY-r17 | PositionStateVector-r17, |
| positionZ-r17 | PositionStateVector-r17, |
| velocityVX-r17 | VelocityStateVector-r17, |
| velocityVY-r17 | VelocityStateVector-r17, |
| velocityVZ-r17 | VelocityStateVector-r17 |

}

| | |
|---|---|
| Orbital-r17 ::= | SEQUENCE { |
| semiMajorAxis-r17 | INTEGER (0..8589934591), |
| eccentricity-r17 | INTEGER (0..1048575), |
| periapsis-r17 | INTEGER (0..268435455), |
| longitude-r17 | INTEGER (0..268435455), |
| inclination-r17 | INTEGER (−67108864..67108863), |
| meanAnomaly-r17 | INTEGER (0..268435455) |

}
PositionStateVector-r17 ::= INTEGER (−33554432..33554431)
VelocityStateVector-r17 ::= INTEGER (−131072..131071)

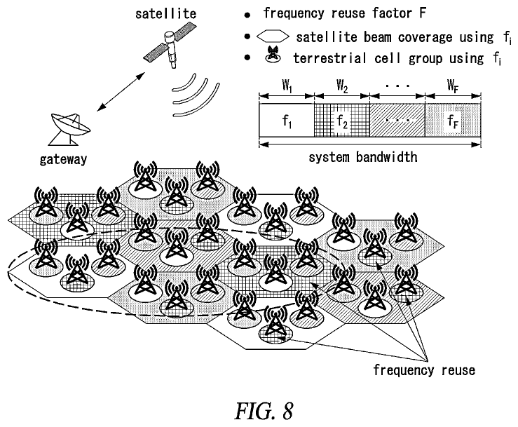

FIG. 8 is a conceptual diagram illustrating an exemplary embodiment of a communication system to which a frequency reuse technique is applied.

As shown in FIG. 8, a communication system may be configured to include an NTN and/or a TN. For example, the communication system may include the NTN which is configured to provide services to a predetermined coverage and includes one or more satellites and one or more gateways. Here, the NTN may be configured identically or similarly to at least one of the exemplary embodiments of the NTN described with reference to FIGS. 1A to 7B. The one or more satellites and one or more gateways included in the NTN may be configured identically or similarly to the satellites 110, 211, and 212 and gateways 130 and 230 described with reference to FIGS. 1A and 2A. The NTN may provide services to communication nodes on the ground using multiple beams. Meanwhile, the communication system may include the TN which is configured to provide services to a predetermined coverage and includes one or more terrestrial cells. Alternatively, the communication system may be an integrated satellite and terrestrial (IST) system configured to include the NTN and the TN.

In the communication system, a frequency reuse technique may be applied to efficiently provide services to multiple users using limited radio resources. For example, when a plurality of beams used in the NTN shown in FIG. 8 and/or a plurality of cells in the TN use the same frequency band, inter-beam interference and/or inter-cell interference may occur. In the instant case, the frequency reuse technique may be used to alleviate interference caused due to use of the same frequency band. In particular, in a communication environment (such as NTN, etc.) where resources such as frequency and power are very limited, using the frequency reuse technique may be advantageous for efficient resource allocation. The resource allocation may be performed by a predetermined device (hereinafter referred to as ‘resource allocation device’) included in the communication system.

In an exemplary embodiment of the communication system, the frequency reuse technique may be applied in a scheme that allows the same frequency to be used by different beams or cells with sufficient geographical separation distance. For example, the resource allocation device for the satellite and/or terrestrial cell using multiple beams may perform allocation of frequency bands based on a frequency reuse factor (FRF) F. For example, if the FRF F is greater than 1, the resource allocation device may configure a plurality of bandwidths w₁, w₂, . . . , and w_{F} by dividing the entire available frequency bandwidth (e.g. system frequency bandwidth) based on the FRF F. The bandwidths w₁, w₂, . . . , and w_{F} may have representative frequencies f₁, f₂, . . . , and f_{F}, respectively. The satellite using multiple beams may control the coverages of these beams by using a bandwidth with the same representative frequency, ensuring they are geographically spaced from each other based on the frequency reuse technique.

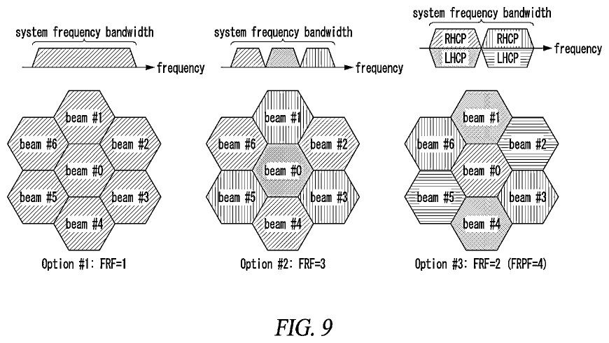

FIG. 9 is a conceptual diagram illustrating exemplary embodiments of radio resource operation schemes in the communication system to which the frequency reuse technique is applied.

As shown in FIG. 9, the communication system may support a frequency reuse technique. Here, the frequency reuse technique may be the same or similar to the frequency reuse technique described with reference to FIG. 8. Hereinafter, in describing exemplary embodiments of radio resource operation schemes in the communication system to which the frequency reuse technique is applied with reference to FIG. 9, description redundant with those described with reference to FIGS. 1A to 8 may be omitted.

The communication system to which the frequency reuse technique is applied may support one or more options related to operations of the system frequency bandwidth. The respective options may support the same or different FRFs. Each option may support one or more resource configurations (hereinafter referred to as N-th resource configuration) related to available frequency bandwidth and/or applied polarization. Here, N may be a natural number. For example, the communication system may support at least some of the following options.

Option #1: FRF=1, no polarization applied.

If the FRF is 1 and no polarization is applied, as in Option #1, the system frequency bandwidth may be operated as one bandwidth without being divided. For radio resources operated according to Option #1, one resource configuration (hereinafter referred to as first resource configuration) related to available frequency bandwidth may be applied. In other words, in Option #1, the first resource configuration may be applied equally to all beams (beam #0 to beam #6). Here, the first resource configuration may indicate that radio resources corresponding to the entire system frequency bandwidth are available. In Option #1, the terminal may communicate with the satellite based on radio resources (such as bandwidth part (BWP)) according to the first resource configuration.

Option #2: FRF=3, no polarization applied.

If the FRF is 3 and no polarization is applied, as in Option #2, the system frequency bandwidth may be operated as being divided into three bandwidths. For example, the system frequency bandwidth may be divided into three divided frequency bandwidths w₁, w₂, and w₃. For radio resources operated according to Option #2, three resource configurations (hereinafter, first to third resource configurations) related to available frequency bandwidth may be applied. In other words, in Option #2, one of the first to third resource configurations may be applied to each of all the beams (beam #0 to beam #6). Here, the first resource configuration may indicate that radio resources corresponding to the divided frequency bandwidth w₁ are available. The second resource configuration may indicate that radio resources corresponding to the divided frequency bandwidth w₂ are available. The third resource configuration may indicate that radio resources corresponding to the divided frequency bandwidth w₃ are available. Different resource configurations may be applied to adjacent beams among all the beams. For example, the first resource configuration may be applied to beam #2, beam #4, beam #6, etc., the second resource configuration may be applied to beam #0, etc., and the third resource configuration may be applied to beam #1, beam #3, beam #5, etc. In Option #2, the terminal may communicate with the satellite based on radio resources (such as BWP) according to the first to third resource configurations.

Option #3: FRF=2, polarization applied.

If the FRF is 2 and polarization is applied, as in Option #3, the system frequency bandwidth may be operated as being divided into two bandwidths. For example, the system frequency bandwidth may be divided into two divided frequency bandwidths w₁ and w₂. A specific polarization may be applied to each of the divided frequency bandwidths w₁ and w₂. For example, assuming that two types of polarization (i.e. first polarization and second polarization) are applicable, for radio resources operated according to Option #3, four resource configurations (hereinafter, first to fourth resource configurations) related to available frequency bandwidth and applied polarization may be applied. In other words, in Option #3, one of the first to fourth resource configurations may be applied to each of all the beams (beam #0 to beam #6). For example, the first resource configuration may indicate that radio resources corresponding to the divided frequency bandwidth w₁ are available and the first polarization is applied. The second resource configuration may indicate that radio resources corresponding to the divided frequency bandwidth w₂ are available and the first polarization is applied. The third resource configuration may indicate that radio resources corresponding to the divided frequency bandwidth w₁ are available and the second polarization is applied. The fourth resource configuration may indicate that radio resources corresponding to the divided frequency bandwidth w₂ are available and the second polarization is applied. Different resource configurations may be applied to adjacent beams among all the beams. For example, the first resource configuration may be applied to beam #0, etc., the second resource configuration may be applied to beam #3, beam #6, etc., the third resource configuration may be applied to beam #1, beam #4, etc., and the fourth resource configuration may be applied to beam #2, beam #5, etc. In Option #3, the terminal may communicate with the satellite based on radio resources (such as BWP) according to the first to fourth resource configurations.

In the case where polarization is applied, as in Option #3, more than one type of polarization (e.g. first polarization, second polarization, etc.) may be applied. For example, one or more types of polarization may correspond to right-handled circular polarization (RHCP), left-handled circular polarization (LHCP), etc. However, these are merely an example for convenience of description, and exemplary embodiments of the radio resource operation schemes are not limited thereto.

In an exemplary embodiment of the communication system, an extended frequency reuse/polarization factor (FRPF) may be defined by reflecting the polarization. The FRPF may refer to the number of resource configurations that are configured differently based on the frequency reuse technique and polarizations. For example, since four resource configurations are distinguished based on frequency reuse and polarizations in Option #3, Option #3 may be expressed by ‘FRPF=4’. On the other hand, for Option #1 and Option #2 to which polarization is not applied, the FRPF value may not be defined or may be defined to have the same value as the FRF. For convenience of description, the FRPF value may be expressed to replace the FRF value. For example, in case of Option #3 where FRF=2 and FRPF=4, it may be expressed as ‘FRF=4’ for convenience of description.

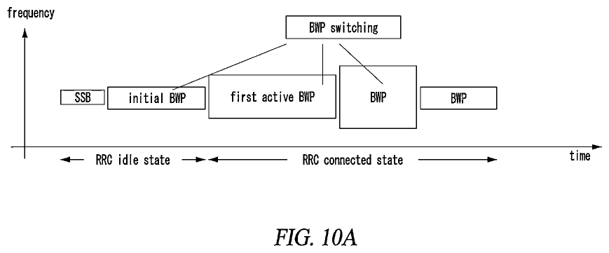

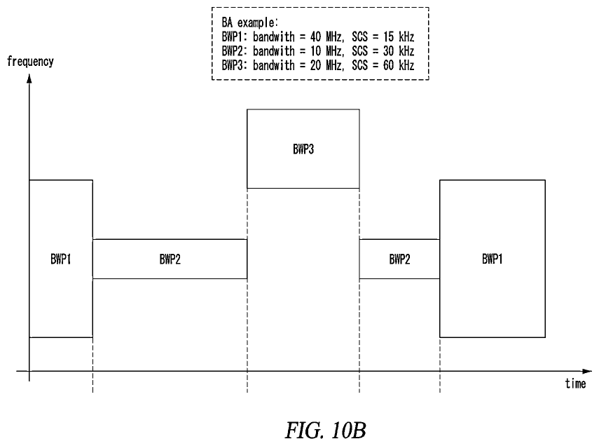

FIGS. 10A and 10B are conceptual diagrams illustrating exemplary embodiments of a BWP operation method in a communication system.

As shown in FIGS. 10A and 10B, one or more BWPs may be operated in one communication system. For example, a network entity such as a base station or satellite may allocate one or more BWPs to each terminal. Hereinafter, in describing exemplary embodiments of the BWP operation method in the communication system with reference to FIGS. 10A and 10B, description redundant with those described with reference to FIGS. 1A to 9 may be omitted.

When using a predetermined carrier frequency band in the communication system, a band with a size smaller than the carrier frequency band may be configured and used within the carrier frequency band. For example, in the communication system, one or more BWPs with a bandwidth smaller than the specific carrier frequency band may be configured within the specific carrier frequency band.

In the exemplary embodiment shown in FIG. 10A, four BWPs may be configured in one terminal. One BWP among the four BWPs may be an active BWP (i.e. first active BWP). A BWP among the four BWPs, which is most advanced in the time domain, may be referred to as an initial BWP. The initial BWP may be allocated to a position after a position where a synchronization signal block (SSB) is allocated in the time domain, and may be used in the RRC idle state. The remaining three BWPs excluding the initial BWP may be used in the RRC connected state. The four BWPs may be used while switching between them. This may be referred to as a ‘BWP switch’ or ‘BWP switching’. One BWP may be used at each time.

In the exemplary embodiment shown in FIG. 10B, three BWPs may be configured in one terminal. The three BWPs may be referred to as BWP1, BWP2, and BWP3, respectively. The three BWPs may have the same or different bandwidths, positions, and subcarrier spacings (SCSs). For example, the bandwidth and SCS of BWP1 may be 40 MHz and 15 kHz, respectively. The bandwidth and SCS of BWP2 may be 10 MHz and 30 kHz, respectively. The bandwidth and SCS of BWP3 may be 20 MHz and 60 kHz, respectively. The three BWPs may be used while switching between them.

As described with reference to FIGS. 10A and 10B, a plurality of BWPs may be used, switching between them based on BWP switching. One BWP may be used at each time. The BWP switching may be controlled based on RRC signaling, physical downlink control channel (PDCCH), DCI, inactivity timer, etc.

In the RRC idle state, the terminal may attempt initial access through the initial BWP allocated to a beam with the highest signal strength identified through periodic SSB reception. Therefore, a separate operation for beam switching may not be required. On the other hand, a change in BWP configuration (i.e. BWP configuration change) may be required when performing beam switching in the RRC connected state. If the BWP configuration is changed, the BWP switching may be performed to one of BWPs whose configurations have been changed.

The initial BWP (or initial downlink BWP, initial uplink BWP, etc.) may be configured by a network entity through system information (e.g. SIB1) or RRC signaling (e.g. dedicated RRC signaling). In particular, common parameters for an initial downlink BWP or initial uplink BWP of a primary cell (PCell) may be provided to each terminal from the network entity through system information. Other BWPs may be configured or defined based on RRC message(s). In other words, the RRC message (or RRC signaling) may have BWP-related configurations. For example, a ServingCellConfig information element (IE) in the RRC message may have IEs or parameters that are the same or similar to those in Table 7.

TABLE 7

| | |
|---|---|
| ServingCellConfig ::= | SEQUENCE { |
| tdd-UL-DL-ConfigurationDedicated | TDD-UL-DL-ConfigDedicated |

OPTIONAL, -- Cond TDD

| | |
|---|---|
| initialDownlinkBWP | BWP-DownlinkDedicated |

OPTIONAL, -- Need M

| | |
|---|---|
| downlinkBWP-ToReleaseList | SEQUENCE (SIZE |

(1..maxNrofBWPs)) OF BWP-Id
OPTIONAL, -- Need N

| | |
|---|---|
| downlinkBWP-ToAddModList | SEQUENCE (SIZE |

(1..maxNrofBWPs)) OF BWP-Downlink
OPTIONAL, -- Need N

| | |
|---|---|
| firstActiveDownlinkBWP-Id | BWP-Id |

OPTIONAL, -- Cond SyncAndCellAdd

| | |
|---|---|
| bwp-InactivityTimer | ENUMERATED {ms2, ms3, ms4, |

ms5, ms6, ms8, ms10, ms20, ms30,

ms40,ms50,

ms60, ms80,ms100, ms200,ms300, ms500,

ms750, ms1280,

ms1920, ms2560, spare10, spare9, spare8,

| | |
|---|---|
| | spare7, spare6, |
| spare5, spare4, spare3, spare2, spare1 } | OPTIONAL, -- Need R |
| defaultDownlinkBWP-Id | BWP-Id |

OPTIONAL, -- Need S

| | |
|---|---|
| uplinkConfig | UplinkConfig |

OPTIONAL, -- Need M
...
}

| | |
|---|---|
| UplinkConfig ::= | SEQUENCE { |
| initialUplinkBWP | BWP-UplinkDedicated |

OPTIONAL, -- Need M

| | |
|---|---|
| uplinkBWP-ToReleaseList | SEQUENCE (SIZE |

(1..maxNrofBWPs)) OF BWP-Id
OPTIONAL, -- Need N

| | |
|---|---|
| uplinkBWP-ToAddModList | SEQUENCE (SIZE |

(1..maxNrofBWPs)) OF BWP-Uplink
OPTIONAL, -- Need N

| | |
|---|---|
| firstActiveUplinkBWP-Id | BWP-Id |

OPTIONAL, -- Cond SyncAndCellAdd
...
}

As shown in Table 7, the ServingCellConfig IE in the RRC message may have IEs or parameters related to bandwidth, SCS, cyclic prefix (CP), frequency position, etc. Among the IEs shown in Table 7, a downlinkBWP-ToAddModList IE may have a BWP-Downlink IE. The BWP-Downlink IE may have IEs of parameters that are the same or similar to those in Table 8.

TABLE 8

| BWP-Downlink ::= | SEQUENCE { |
|---|---|
| bwp-Id | BWP-Id, |
| bwp-Common | BWP-DownlinkCommon |
| OPTIONAL, -- Cond SetupOtherBWP | |
| bwp-Dedicated | BWP-DownlinkDedicated |

OPTIONAL, -- Cond SetupOtherBWP
...
}

As shown in Table 8, the BWP-Downlink IE may have bwp-Id, BWP-DownlinkCommon, BWP-DownlinkDedicated, etc. Here, BWP-DownlinkCommon and BWP-DownlinkDedicated may be expressed as Table 9 and Table 10, respectively.

TABLE 9
BWP-DownlinkCommon

| genericParameters | locationAndBandwi | INTEGER (0 ... 37949) |
|---|---|---|
| | dth | |
| | subcarrierSpacing | ENUMERATED {kHz15, kHz30, kHz60, |
| | | kHz120, kHz240, spare3, spare2, spare1} |
| | cyclicPrefix | ENUMERATED { extended } |
| pdcch- | SetupRelease { PDCCH-ConfigCommon } | |
| ConfigCommon | | |
| pdsch- | SetupRelease { PDSCH-ConfigCommon } | |
| ConfigCommon | | |

TABLE 10

| BWP-DownlinkDedicated | |
|---|---|
| pdcch-Config | SetupRelease { PDCCH-Config } |
| pdsch-Config | SetupRelease { PDSCH-Config } |
| sps-Config | SetupRelease { SPS-Config } |
| radioLinkMonitoringConfig | SetupRelease { RadioLinkMonitoringConfig } |

In the NTN environment using multiple beams, beam switching may occur continuously due to movement of the satellite or terminal. In particular, when the FRF (or FRPF) is greater than 1, configuration regarding frequency and/or polarization may need to be changed for beam switching depending on the FRF (or FRPF). Accordingly, configuration of BWPs allocated to each terminal may need to be changed each time beam switching is performed. In particular, in case of a satellite using an Earth-fixed type service link (or Earth-Fixed Beam (EFB)), rapid BWP configuration changes for terminals served by the beam may be required during beam switching. Accordingly, the complexity of signaling operations for the BWP configuration changes may increase. In the NTN environment where the value of FRF (or FRPF) is greater than 1, a radio resource operation technique may be required to improve the efficiency of beam switching.

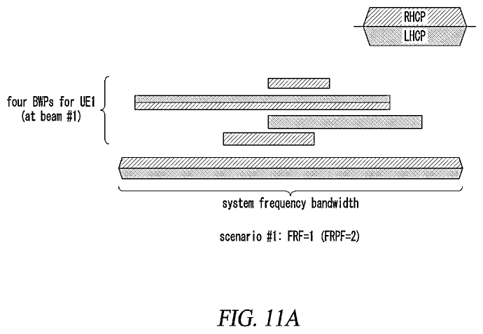

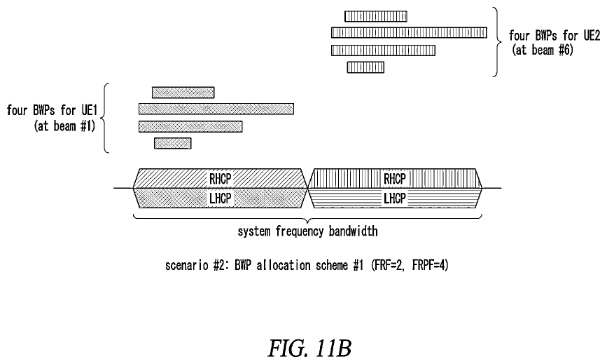

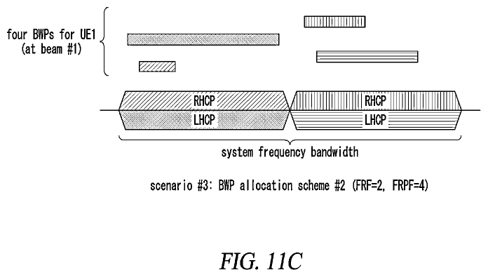

FIGS. 11A to 11C are conceptual diagrams illustrating exemplary embodiments of BWP configuration scenarios in a communication system.

As shown in FIGS. 11A to 11C, one or more BWPs may be operated in one communication system. For example, a network entity such as a base station or satellite may allocate one or more BWPs to each terminal. Hereinafter, in describing exemplary embodiments of BWP configurations scenarios in the communication system with reference to FIGS. 11A to 11C, description redundant with those described with reference to FIGS. 1A to 10B may be omitted.

In a BWP configuration scenario #1 shown in FIG. 11A, FRF may be 1 and FRPF may be 2. That is, in the BWP configuration scenario #1, a system frequency bandwidth may be operated as one bandwidth without being divided, and a polarization, such as the first polarization or the second polarization, may be applied to the entire system frequency bandwidth. The first polarization may be RHCP, and the second polarization may be LHCP. However, this is merely an example for convenience of description, and exemplary embodiments of BWP configuration scenarios in the communication system are not limited thereto. In the BWP configuration scenario #1, four BWPs may be configured for one terminal. In the BWP configuration scenario #1, BWPs each having a predetermined position and bandwidth in the same frequency band (i.e. entire system frequency band) may be allocated, and polarizations may be applied to adjacent beams. In the instant case, even if beam switching is performed, the same frequency band and polarization may continue to be applied to each BWP. Therefore, even if beam switching is performed, the BWP configuration may not need to be changed.

In the BWP configuration scenario #2 and BWP configuration scenario #3 shown in FIGS. 11B and 11C, FRF may be 2 and FRPF may be 4. That is, in the BWP configuration scenario #2 and BWP configuration scenario #3, the system frequency bandwidth may be operated as being divided into two bandwidths, and a polarization, such as the first polarization or the second polarization, may be applied to each of the divided frequency bandwidths (e.g. w₁, w₂). In the BWP configuration scenario #2 and BWP configuration scenario #3, four resource configurations (first to fourth resource configurations) may be distinguished based on frequency reuse and polarizations. In the BWP configuration scenario #2 and BWP configuration scenario #3, BWPs based on different resource configurations may be allocated to adjacent beams. In the instant case, even if beam switching is performed, the same frequency band and polarization may continue to be applied to each BWP. Therefore, if beam switching is performed, BWP configuration may need to be changed.

The BWP configuration scenario #2 may be referred to as BWP allocation scheme #1. In the BWP allocation scheme #1, BWPs may be configured only within a polarization and frequency band allocated to each beam. In other words, in the BWP allocation scheme #1, only BWPs to which the resource configuration configured for each beam is applied may be allocated. For example, a UE1 in a coverage of beam #1 may be allocated BWPs to which the third resource configuration is applied. A UE in a coverage of beam #6 adjacent to the coverage of beam #1 may be allocated BWPs to which the second resource configuration is applied. Accordingly, inter-beam interference problems may be easily prevented.

The BWP configuration scenario #3 may be referred to as BWP allocation scheme #2. In the BWP allocation scheme #2, a frequency and polarization applied to a BWP may be determined arbitrarily. In the BWP allocation scheme #2, UEs (or terminals, users, etc.) using the same frequency band and polarization may coexist in adjacent beams. Accordingly, inter-beam interference problems may occur. To solve the inter-beam interference problems, relatively complex signaling procedures and transmission/reception signal processing operations may be required.

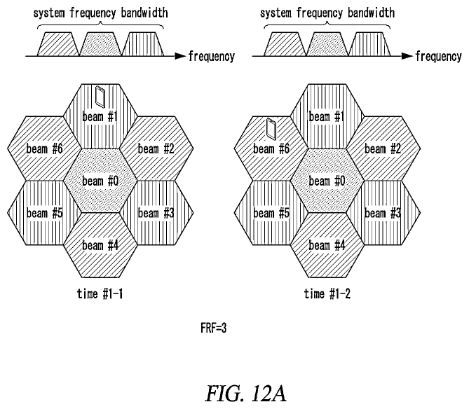

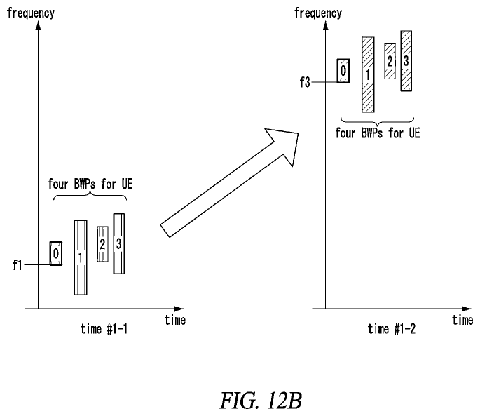

FIGS. 12A and 12B are conceptual diagrams illustrating a first exemplary embodiment of a radio resource operation method in a communication system.

As shown in FIGS. 12A and 12B, one or more BWPs may be operated in one communication system. For example, a network entity such as a base station or satellite may allocate one or more BWPs to each terminal. Here, the one or more BWPs may be operated based on Option #2 described with reference to FIG. 9. Hereinafter, in describing the first exemplary embodiment of the radio resource operation method in the communication system with reference to FIGS. 12A and 12B, description redundant with those described with reference to FIGS. 1A to 11C may be omitted.

Referring to FIG. 12A, application of polarizations may not be considered in beam and BWP operations. FRF may be n. Here, n may be a natural number. FRPF may not be defined or may have the same value as FRF. If n is 1, the system frequency bandwidth may be used without being divided. If n is a natural number greater than 1, the system frequency bandwidth may be divided into n divided frequency bandwidths w₁ to wₙ. Here, n may be a natural number greater than 1. For example, FIG. 12A illustrates a situation where n=3. Hereinafter, the first exemplary embodiment of the radio resource operation method in the communication system will be described using the situation where n=3 as shown in FIG. 12A as an example. However, this is merely an example for convenience of description, and the first exemplary embodiment of the radio resource operation method may be applied equally or similarly to a situation where n has an arbitrary natural number.

If FRF=3 (i.e. n=3), the system frequency bandwidth may be divided into three divided frequency bandwidths (w₁ to w₃). The three divided frequency bandwidths w₁, w₂, and w₃ may each be located at different positions in the frequency domain. The three divided frequency bandwidths w₁, w₂, and w₃ may each have different reference frequencies f₁, f₂, and f₃ in the frequency domain.

One of the first to third resource configuration respectively corresponding to the three divided frequency bandwidths may be applied to multiple beam formed by the satellite. For example, the reference frequency of the divided frequency bandwidth w₁ corresponding to the first resource configuration may be f₁, the reference frequency of the divided frequency bandwidth w₂ corresponding to the second resource configuration may be f₂, and the reference frequency of the divided frequency bandwidth w₃ corresponding to the third resource configuration may be f₃. One of the first to third resource configurations may be applied to each of all beams (beam #0 to beam #6).

The UE may move over time and be located in a coverage corresponding to one of the beams formed by the satellite. For example, at a time #1-1, the UE may be located in a coverage of beam #1 to which the first resource configuration is applied. At a time #1-2, the UE may be located in a coverage of beam #6 to which the third resource configuration is applied.

Referring to FIG. 12B, at the time #1-1, the UE may be located in the coverage of beam #1 to which the first resource configuration is applied. At the time #1-1, the satellite may allocate one or more BWPs to the UE based on the first resource configuration. For example, four BWPs may be allocated to the UE. The IDs of the four BWPs may be expressed as 0, 1, 2, 3, etc., respectively. In the first resource configuration, bandwidths, positions, SCSs, etc. of the BWPs in the frequency domain may be the same or different. The BWPs may be allocated to different positions in the time domain.

At the time #1-2, the UE may move from the coverage of beam #1 to which the first resource configuration is applied to the coverage of beam #6 to which the third resource configuration is applied. In the instant case, beam switching from beam #1 to beam #6 may be performed. Beam and BWP operations for the UE may need to be performed based on the third resource configuration rather than the first resource configuration. In other words, BWPs based on the third resource configuration may need to be newly configured for the UE. In the instant case, BWP switching or BWP configuration change based on the third resource configurations may be performed.

Specifically, the UE may generate measurement reports periodically or aperiodically. Here, the measurement report may include information on a measurement result (or measurement value) regarding a reception strength of a downlink signal received from the satellite. For example, the measurement report may include information on an SSB L1-reference signal reception power (RSRP). The UE may transmit the generated measurement report to the satellite. The satellite may receive measurement reports from the UE periodically or aperiodically. The satellite may identify information on the measurement result included in the measurement report received from the UE. The satellite may determine whether to perform beam switching based on the information on the measurement result included in the measurement report received from the UE. That is, beam switching may be determined based on the information on the measurement result of the reception strength of the downlink signal received by the UE from the satellite.

For example, when the satellite is providing services to the UE through a serving beam, if the UE is still located in a coverage of the serving beam, a reception strength measurement value for the serving beam may be greater than reception strength measurement values for other beams. In the instant case, the satellite may determine that beam switching for the UE is not necessary. On the other hand, when the UE moves from the coverage of the serving beam to a coverage of another beam (hereinafter referred to as ‘target beam’), a reception strength measurement value of the target beam at the UE may be greater than the reception strength measurement value of the serving beam at the UE. In the instant case, the satellite may determine that beam switching for the UE is required. However, this is merely an example for convenience of description, and the first exemplary embodiment of the radio resource operation method in the communication system is not limited thereto. For example, in an exemplary embodiment of the communication system, beam switching may be determined based on a predetermined criterion or trigger defined based on the measurement report. Meanwhile, in another exemplary embodiment of the communication system, beam switching may be determined based on a predetermined timer.

If beam switching is not determined, the satellite may later receive measurement reports received from the UE. On the other hand, if beam switching is determined, the satellite may perform an operation to switch the serving beam for the UE to the target beam. Here, the satellite may determine BWP configuration change information to be transmitted to the UE based on comparison between a resource configuration corresponding to the serving beam (e.g. the first resource configuration corresponding to beam #1) and a resource configuration corresponding to the target beam (e.g. the third resource configuration corresponding to beam #6). The BWP configuration change information may include a frequency change value Δf. The BWP configuration change information may be transmitted from the satellite to the UE, for example based on RRC signaling.

In the situation shown in FIGS. 12A and 12B, the satellite may identify a frequency reference value (i.e. reference frequency f₁ of the divided frequency bandwidth w₁) corresponding to the first resource configuration corresponding to beam #1 (i.e. serving beam) and a frequency reference value (i.e. reference frequency f₃ of the divided frequency bandwidth w₃) corresponding to the third resource configuration corresponding to beam #6 (i.e. target beam). The satellite may determine the frequency change value Δf based on a difference between the frequency reference value f₁ corresponding to the first resource configuration and the frequency reference value f₃ corresponding to the third resource configuration. For example, the frequency change value Δf may be determined identically or similarly to Equation 1.

$$Δ f = {f}_{3} - {f}_{1} \qquad [ Equation 1 ]$$

The satellite may transmit the BWP configuration change information including information on the frequency change value Δf determined as shown in Equation 1 to the UE. The UE may receive the BWP configuration change information from the satellite. The UE may identify the information on the frequency change value Δf included in the BWP configuration change information received from the satellite.

As described above, in an exemplary embodiment of the communication system, the satellite may determine the frequency change value Δf and inform the UE of the determined frequency change value Δf through the BWP configuration change information. However, this is merely an example for convenience of description, and the first exemplary embodiment of the radio resource operation method in the communication system is not limited thereto.

For example, in another exemplary embodiment of the communication system, the frequency change value Δf may be calculated at the UE rather than the satellite. In the instant case, the BWP configuration change information transmitted by the satellite to the UE may be defined to include information required for the UE to identify the frequency change value Δf. For example, the BWP configuration change information may be generated based on at least part of information related to the divided frequency bandwidth corresponding to the serving beam (e.g. the divided frequency bandwidth w₁ corresponding to the first resource configuration corresponding to beam #1) and information related to the divided frequency bandwidth corresponding to the target beam (e.g. the divided frequency bandwidth w₃ corresponding to the third resource configuration corresponding to beam #3). Here, the information related to each divided frequency bandwidth may include, for example, information on an index, identifier, frequency-domain position, frequency reference value, etc. of each divided frequency bandwidth. Meanwhile, the BWP configuration change information may be defined to include a frequency change index according to a preconfigured (or predefined) first table. Here, the first table may include frequency change indexes (e.g. natural number indexes) corresponding to the sizes of the frequency change value Δf. That is, the UE may identify the frequency change index included in the BWP configuration change information received from the satellite, and identify the frequency change value Δf corresponding to the identified frequency change index based on the first table. To this end, information on the first table may be shared in advance between the UE and the satellite.

The UE may identify the information related to the divided frequency bandwidth corresponding to the serving beam and/or the divided frequency bandwidth corresponding to the target beam, based on the BWP configuration change information received from the satellite. The UE may calculate the frequency change value Δf based on the identified information. For example, the UE may calculate the frequency change value Δf in the same or similar manner as Equation 1. In the instant case, the satellite may receive information on the frequency change value Δf calculated by the UE from the UE, or may calculate the frequency change value Δf independently from the UE.

The UE and/or satellite may perform a BWP reconfiguration procedure based on the frequency change value Δf. In the BWP reconfiguration procedure, the UE may identify information on one or more target BWPs by applying the same frequency change value Δf to all of one or more BWPs (i.e. serving BWPs) previously allocated to the UE. For example, the UE may identify information on the one or more target BWPs by applying the same frequency change value Δf to all of the one or more serving BWPs (e.g. BWP IDs 0, 1, 2, and 3). That is, the one or more target BWPs may be considered as a result of moving all of the one or more serving BWPs in parallel in the frequency domain. Here, a group of the one or more serving BWPs may be referred to as a serving BWP group (or first BWP group). Meanwhile, a group of the one or more target BWPs may be referred to as a target BWP group (or second BWP group).

Meanwhile, in the BWP reconfiguration procedure, the satellite may identify information on the one or more target BWPs based on the frequency change value Δf and the one or more serving BWPs. The above-described identification operation of the satellite may be the same or similar to the identification operation of the UE. The satellite may determine BWP IDs of the respective one or more target BWPs to be the same as BWP IDs of the respective one or more serving BWPs. In other words, the satellite may assign a BWP ID that is the same as a BWP ID of each of the one or more serving BWPs to each of the one or more target BWPs. For example, the target BWP determined by applying the frequency change value Δf to the serving BWP with BWP ID 0 may have BWP ID 0. The target BWP determined by applying the frequency change value Δf to the serving BWP with BWP ID 1 may have BWP ID 1. The target BWP determined by applying the frequency change value Δf to the serving BWP with BWP ID 2 may have BWP ID 2. The target BWP determined by applying the frequency change value Δf to the serving BWP with BWP ID 3 may have BWP ID 3.

The UE may switch to the target BWPs with the same BWP IDs as the BWP IDs of the serving BWPs, based on the BWP reconfiguration procedure. When beam switching is determined as the UE moves from the coverage of the serving beam to the coverage of the target beam as described above, BWP switching corresponding to the determined beam switching may be effectively determined and performed.

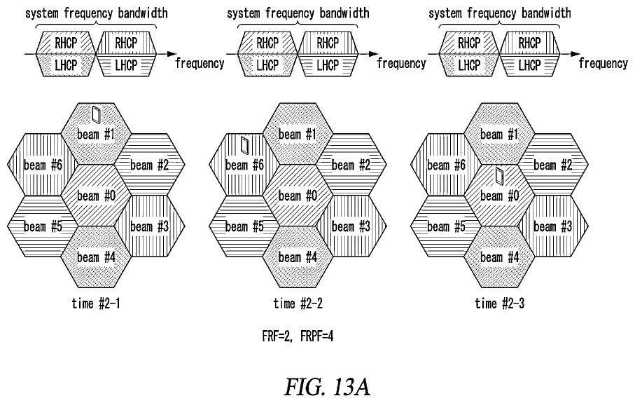

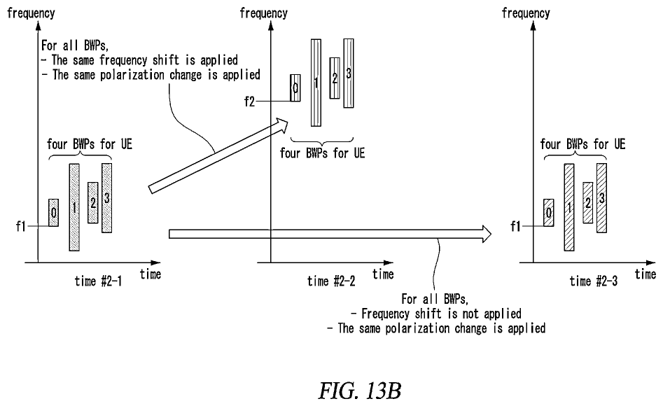

FIGS. 13A and 13B are conceptual diagrams illustrating a second exemplary embodiment of a radio resource operation method in a communication system.

As shown in FIGS. 13A and 13B, one or more BWPs may be operated in one communication system. For example, a network entity such as a base station or satellite may allocate one or more BWPs to each terminal. Here, the one or more BWPs may be operated based on the BWP allocation scheme described with reference to FIG. 11B. Hereinafter, in describing the second exemplary embodiment of the radio resource operation method in the communication system with reference to FIGS. 13A and 13B, description redundant with those described with reference to FIGS. 1A to 12B may be omitted.

Referring to FIG. 13A, application of polarizations may be considered in beam and BWP operations. If FRF=n, FRPF may be 2n. If n is 1, the system frequency bandwidth may be used without being divided. If n is a natural number greater than 1, the system frequency bandwidth may be divided into n divided frequency bandwidths w₁ to wₙ. For example, FIG. 13A illustrates a situation where n=2. Hereinafter, the second exemplary embodiment of the radio resource operation method in the communication system will be described using the situation where n=2 as shown in FIG. 13A as an example. However, this is merely an example for convenience of description, and the second exemplary embodiment of the radio resource operation method in the communication system may be applied equally or similarly to a situation where n has an arbitrary natural number value.

If FRF=2 (i.e. n=2), the system frequency bandwidth may be divided into two divided frequency bandwidths w₁ and w₂. The two divided frequency bandwidths w₁ and w₂ may each be located at different positions in the frequency domain. The two divided frequency bandwidths w₁ and w₂ may each have different frequency reference values f₁ and f₂ in the frequency domain. Meanwhile, one of one or more polarizations may be applied to each of multiple beams formed by the satellite. The polarization applied to each of the multiple beams may be expressed as a first polarization, a second polarization, etc. The polarization applied to each of the multiple beams may correspond to RHCP, LHCP, etc. However, this is merely an example for convenience of description, and the second exemplary embodiment of the radio resource operation method in the communication system is not limited thereto.

One of the first to fourth resource configurations corresponding to each of the two divided frequency bandwidths and the applied polarization may be applied to each of the multiple beams formed by the satellite. For example, the frequency reference value of the divided frequency bandwidth w₁ corresponding to the first and second resource configurations may be f₁, and the frequency reference value of the divided frequency bandwidth w₂ corresponding to the third and fourth resource configurations may be f₂. The first polarization may be applied to beam(s) to which the first and fourth resource configurations are applied, and the second polarization may be applied to beam(s) to which the second and third resource configurations are applied.

The UE may move over time and be located in a coverage corresponding to one of the beams formed by the satellite. For example, at a time #2-1, the UE may be located in a coverage of beam #1 to which the first resource configuration is applied. At a time #2-2, the UE may be located in a coverage of beam #6 to which the third resource configuration is applied. At a time #2-3, the UE may be located in a coverage of beam #0 to which the second resource configuration is applied. Here, the time #2-2 and the time #2-3 may be unrelated to each other in the domain. The time #2-2 may refer to a time period after the time #2-1. The time #2-3 may refer to another time period after the time #2-1.

Referring to FIG. 13B, at the time #2-1, the UE may be located in the coverage of beam #1 to which the first resource configuration is applied. At the time #2-1, the satellite may allocate one or more BWPs to the UE based on the first resource configuration. For example, four BWPs may be allocated to the UE. IDs of the four BWPs may be expressed as 0, 1, 2, 3, etc., respectively. Additionally, the satellite may form beam #1 by applying the first polarization based on the first resource configuration.

At the time point #2-2, the UE may move from the coverage of beam #1 to which the first resource configuration is applied to the coverage of beam #6 to which the third resource configuration is applied. In the instant case, beam switching from beam #1 to beam #6 may be performed. Beam and BWP operations for the UE may need to be performed based on the third resource configuration rather than the first resource configuration. In other words, the BWPs and/or applied polarization may need to be determined for the UE based on the third resource configuration. In the instant case, BWP switching or BWP configuration change based on the third resource configuration may be performed.

At the time #2-3, the UE may move from the coverage of beam #1 to which the first resource configuration is applied to the coverage of beam #0 to which the second resource configuration is applied. In the instant case, beam switching from beam #1 to beam #0 may be performed. Beam and BWP operations for the UE may need to be performed based on the second resource configuration rather than the first resource configuration. In other words, the BWPs and/or applied polarization may need to be determined for the UE based on the second resource configuration. In the instant case, BWP switching or BWP configuration change based on the second resource configuration may be performed.

Specifically, the UE may generate measurement reports periodically or aperiodically. The UE may transmit the generated measurement report to the satellite. The satellite may receive the measurement reports from the UE periodically or aperiodically. The satellite may determine whether to perform beam switching based on information on the measurement results included in the measurement report received from the UE.

Specifically, the UE may generate measurement reports periodically or aperiodically. The UE may transmit the generated measurement report to the satellite. The satellite may receive measurement reports from the UE periodically or aperiodically. The satellite may determine whether to perform beam switching based on the information on the measurement result included in the measurement report received from the UE.

If beam switching is determined, the satellite may perform an operation to switching the serving beam for the UE to the target beam. Here, the satellite may determine BWP configuration change information to be transmitted to the UE based on comparison between a resource configuration corresponding to the serving beam (e.g. the first resource configuration corresponding to beam #1) and a resource configuration corresponding to the target beam (e.g. the third resource configuration corresponding to beam #6). The BWP configuration change information may include information on the frequency change value Δf and/or a polarization change indicator. Here, the polarization change indicator may indicate whether to change the polarization applied to the beam (i.e. ‘change the polarization’ or ‘maintain the polarization’).

For example, in an exemplary embodiment of the communication system, the UE may be located in the coverage of beam #1 as in the time #2-1 and then move to the coverage of beam #6 as in the time #2-2. In the instant case, the satellite may identify the frequency reference value (i.e. frequency reference value f₁ of the divided frequency bandwidth w₁) corresponding to the first resource configuration corresponding to beam #1 (i.e. serving beam) and the frequency reference value (i.e. frequency reference value f₃ of the divided frequency bandwidth w₃) corresponding to the third resource configuration corresponding to beam #6 (i.e. target beam). The satellite may determine the frequency change value Δf based on a difference between the frequency reference value f₁ corresponding to the first resource configuration and the frequency reference value f₃ corresponding to the third resource configuration. For example, the frequency change value Δf may be determined identically or similarly to Equation 1.

Meanwhile, the satellite may identify information on the polarization (i.e., information of the first polarization applied to beam #1) corresponding to the first resource configuration corresponding to beam #1 (i.e. serving beam) and information on the polarization (i.e. information of the second polarization applied to the beam #6) corresponding to the third resource configuration corresponding to beam #6 (i.e. target beam). Since the first polarization corresponding to the first resource configuration and the second polarization corresponding to the third resource configuration are different from each other, the polarization change indicator may be determined to indicate ‘change the polarization (i.e. the polarization applied to the beam is changed)’.

The satellite may transmit BWP configuration change information including the frequency change value Δf determined as in Equation 1 and/or polarization change indicator to the UE. The UE may receive the BWP configuration change information from the satellite. The UE may identify the frequency change value Δf and/or polarization change indicator included in the BWP configuration change information received from the satellite.

As described above, in an exemplary embodiment of the communication system, the satellite may determine the frequency change value Δf and/or the polarization change indicator, and inform the UE of the determined frequency change value Δf and/or the polarization change indicator through the BWP configuration change information. However, this is merely an example for convenience of description, and the second exemplary embodiment of the radio resource operation method in the communication system is not limited thereto.

For example, the frequency change value Δf may be determined by the UE rather than the satellite. In the instant case, the UE may identify information related to the divided frequency bandwidth corresponding to the serving beam and/or the divided frequency bandwidth corresponding to the target beam, based on the BWP configuration change information received from the satellite. The UE may calculate the frequency change value Δf based on the identified information.

Meanwhile, the polarization change indicator may be defined to include information on the polarization applied to the target beam. In the instant case, the UE may identify information on the second polarization applied to the target beam based on the BWP configuration change information received from the satellite. The UE may identify that the second polarization is applied to beam #6, the target beam, without separately identifying whether to change the polarization.

The UE and/or satellite may perform a BWP reconfiguration procedure based on the frequency change value Δf and/or the polarization change indicator. In the BWP reconfiguration procedure, the frequency change value Δf may be applied equally to all of one or more serving BWPs to determine one or more target BWPs. Each of the one or more target BWPs may be assigned a BWP ID that is the same as the BWP ID of each of the one or more serving BWPs. Meanwhile, the second polarization different from the first polarization applied to the serving beam transmitted based on the one or more serving BWPs may be applied to the target beam transmitted based on the one or more target BWPs. Based on the BWP reconfiguration procedure, the UE may switch to the target BWPs having the same BWP IDs as the BWP IDs of the serving BWPs, and receive a beam with a different polarization applied from the existing one through the switched BWPs.

On the other hand, in another exemplary embodiment of the communication system, the UE may be located in the coverage of beam #1 as in the time #2-1 and then move to the coverage of beam #0 as in the time #2-3. In the instant case the satellite or UE may identify the frequency reference value (i.e. frequency reference value f₁ of the divided frequency bandwidth w₁) corresponding to the first resource configuration corresponding to beam #1 (i.e. serving beam) and the frequency reference value (i.e. frequency reference value f₁ of the divided frequency bandwidth w₁) corresponding to the second resource configuration corresponding to beam #0 (i.e. target beam). The satellite or UE may determine the frequency change value Δf based on a difference between the frequency reference value f₁ corresponding to the first resource configuration and the frequency reference value f₂ corresponding to the second resource configuration. For example, the frequency change value Δf may be determined identically or similarly to Equation 2.

$$Δ f = {f}_{1} - {f}_{1} = 0 \qquad [ Equation 2 ]$$

Meanwhile, the satellite may identify the polarization (i.e. the first polarization applied to beam #1) corresponding to the first resource configuration corresponding to beam #1 (i.e. serving beam) and the polarization (i.e. the second polarization applied to the beam #0) corresponding to the second resource configuration corresponding to beam #0 (i.e. target beam). The satellite may determine a polarization change indicator based on information on the identified polarization.

The UE and/or satellite may perform a BWP reconfiguration procedure based on the frequency change value Δf and/or the polarization change indicator. Since the frequency change value Δf is 0, separate target BWPs are not determined and the serving BWPs may be used as is. In other words, one or more target BWPs, having the same or similar time/frequency resources and BWP IDs as the time/frequency resources and BWP IDs of the one or more serving beams, may be configured. The second polarization different from the first polarization applied to the serving beam transmitted based on the one or more serving BWPs may be applied to the target beam transmitted based on the one or more serving BWPs (or target BWPs). Based on the BWP reconfiguration procedure, the UE may switch to the target BWPs with the same or similar time/frequency resources and BWP IDs as the time/frequency resources and BWP IDs of the serving BWPs, and receive the beam to which the polarization different from the existing one is applied through the switched BWPs.

Meanwhile, at a time #2-4 (not shown), the UE may move from the coverage of beam #1 to which the first resource configuration is applied to the coverage of beam #2 to which the fourth resource configuration is applied. In the instant case, beam switching from beam #1 to beam #2 may be performed. Beam and BWP operations for the UE may need to be performed based on the fourth resource configuration rather than the first resource configuration. In other words, BWPs and/or applied polarization may need to be determined for the UE based on the fourth resource configuration.

Here, the first polarization corresponding to the fourth resource configuration may be the same as the first polarization corresponding to the first resource configuration. When the polarization does not need to be changed in the beam switching process, the polarization change indicator may be defined to indicate ‘maintain the polarization’ or the first polarization.

Alternatively, the BWP configuration change information may be defined to include only the frequency change value Δf without the polarization change indicator. In the instant case, the UE and satellite may perform beam switching based on the same or similar operations as in the first exemplary embodiment of the radio resource operation method described with reference to FIGS. 12A and 12B.

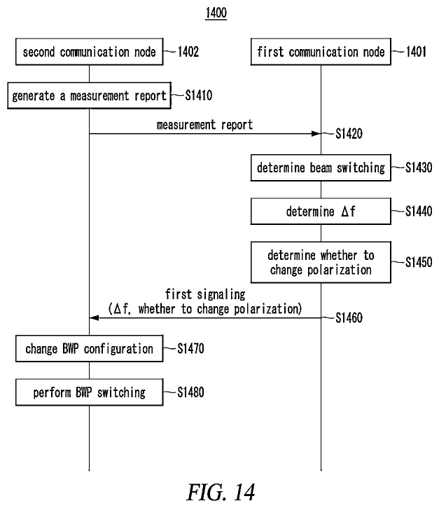

FIG. 14 is a flowchart for describing the first and second exemplary embodiments of the radio resource operation method in the communication system.

As shown in FIG. 14, one or more BWPs may be operated in one communication system. The communication system may include a first communication node 1401 and a second communication node 1402. Here, the first communication node 1401 may be configured identically or similarly to the base station, satellite, network entity, etc. described with reference to at least some of FIGS. 1 to 13B. The second communication node 1402 may be configured identically or similarly to the terminal, user, UE, etc. described with reference to at least some of FIGS. 1 to 13B. The first communication node 1401 and the second communication node 1402 may operate based on the first exemplary embodiment of the radio resource operation method described with reference to FIGS. 12A and 12B and/or the second exemplary embodiment of the radio resource operation method described with reference to FIGS. 13A and 13B. Hereinafter, in describing the first and second exemplary embodiments of the radio resource operation method with reference to FIG. 14, description redundant with those described with reference to FIGS. 1A to 13B may be omitted.

The first communication node 1401 may provide services to the second communication node 1402. The second communication node 1402 may perform communication with the first communication node 1401 through a serving beam within a coverage of a specific beam (hereinafter referred to as ‘serving beam’) among multiple beams formed by the first communication node 1401. For communication between the first communication node 1401 and the second communication node 1402 through the serving beam, one or more serving BWPs may be used. That is, the first communication node 1401 may allocate one or more serving BWPs to the second communication node 1402 for communication with the second communication node 1402 through the serving beam. One or more resource configurations (hereinafter referred to as N-th resource configuration) related to available frequency bandwidth and/or applied polarization may be applied to each of the multiple beams formed by the first communication node 1401. Here, N may be a natural number. Different resource configurations may be applied to adjacent beams among the multiple beams formed by the first communication node 1401. For example, the first resource configuration may be applied to the serving beam, and the N-th resource configurations different from the first resource configuration may be applied to beams adjacent to the serving beam.

When the first communication node 1401 and the second communication node 1402 communicate with each other based on the first exemplary embodiment of the radio resource operation method described with reference to FIGS. 12A and 12B, the N-th resource configuration may include information on a frequency bandwidth available in each of the beams (e.g. at least one of the divided frequency bandwidths w₁ to wₙ). Here, n may be a natural number and may be the same or similar to the FRF value. For example, when the FRF value is 2, the N-th resource configuration may include information on the divided frequency bandwidth w₁ or wₙ available in each of the multiple beams.

Meanwhile, when the first communication node 1401 and the second communication node 1402 communicate with each other based on the second exemplary embodiment of the radio resource operation method described with reference to FIGS. 13A and 13B, the N-th resource configuration may include information on an available frequency bandwidth and/or applied polarization in each of the multiple beams. For example, when FRF=1 and FRPF=2, the N-th resource configuration may include information on an available frequency bandwidth (i.e. the entire system frequency bandwidth) in each of the multiple beams, and/or information on the polarization applied to each of the multiple beams. On the other hand, when FRF=n and FRPF=2n, the N-th resource configuration may include information on a frequency bandwidth available in each of the multiple beams (e.g. at least one of the divided frequency bandwidths w₁ to wₙ) and/or information on a polarization applied to each of the multiple beams. Here, one of one or more polarizations may be applied to each of the multiple beams. The polarization applied to each of the multiple beams may be expressed as the first polarization, the second polarization, etc.

Specifically, the second communication node 1402 may generate measurement reports periodically or aperiodically (S1410). The second communication node 1402 may transmit the generated measurement report to the first communication node 1401 (S1420). The first communication node 1401 may receive the measurement reports periodically or aperiodically from the second communication node 1402 (S1420). The first communication node 1401 may determine whether to perform beam switching based on information on the measurement result included in the measurement report received from the second communication node 1402 (S1430).

If beam switching is determined, the first communication node 1401 may perform an operation to switch the serving beam for the second communication node 1402 to the target beam. Here, the first communication node 1401 may determine BWP configuration change information to be transmitted to the second communication node 1402 based on comparison between the first resource configuration corresponding to the serving beam and the second resource configuration corresponding to the target beam. The BWP configuration change information may include frequency change information and polarization change information.

The first communication node 1401 may determine the frequency change information (S1440). For example, the frequency change information may include information on the frequency change value Δf described with reference to FIG. 12B or FIG. 13B. In the instant case, the first communication node 1401 may determine the frequency change value Δf in step S1440. The determination operation of the frequency change value Δf in step S1440 may be the same or similar to the determination operation of the frequency change value Δf described with reference to FIG. 12B or FIG. 13B. Alternatively, the frequency change information may be defined to include information necessary to identify the frequency change value Δf at the second communication node 1402.

Meanwhile, the first communication node 1401 may determine the polarization change information (S1450). The polarization change information may include the polarization change indicator described with reference to FIG. 13B. In the instant case, the first communication node 1401 may determine the polarization change indicator in step S1450. The determination operation of the polarization change indicator according to step S1450 may be the same or similar to the determination operation of the polarization change indicator described with reference to FIG. 13B.

The first communication node 1401 may transmit the BWP configuration change information indicating the frequency change information and/or polarization change information to the second communication node 1402 (S1460). The BWP configuration change information may be transmitted to the second communication node 1402 through first signaling (e.g. RRC signaling). The second communication node 1402 may receive the BWP configuration change information transmitted from the first communication node (S1460).

The second communication node 1402 may identify BWP configuration change based on the BWP configuration change information received in step S1460 (S1470). For example, the second communication node 1402 may identify information on one or more target BWPs and/or information on a polarization to be applied to a target beam to be received through the one or more target BWPs based on the frequency change information. The second communication node 1402 may perform BWP switching based on the BWP configuration change identified in step S1470 (S1480).

As a result of the BWP switching according to step S1480, the first communication node 1401 and the second communication node 1402 may communicate with each other through a new serving beam (i.e. previous target beam). BWP IDs of one or more BWPs through which the new serving beam is transmitted and received (i.e. new serving BWPs) may be the same as BWP IDs of one or more BWPs through which the existing serving beam was transmitted and received (i.e. existing serving BWPs).

According to the first exemplary embodiment of the radio resource operation method in the communication system, the BWP IDs of the new serving BWPs may be the same or similar to the BWP IDs of the existing serving BWPs. Additionally, the time/frequency resources of the new serving BWPs may be different from the time/frequency resources of the existing serving BWPs.

According to the second exemplary embodiment of the radio resource operation method in the communication system, whether to change frequency resources and whether to change polarization may be determined differently depending on various cases. The time/frequency resources of the new serving BWPs may be the same or different from the time/frequency resources of the existing serving BWPs, and the polarization applied to the new serving beam received through the new serving BWPs may be the same or different from the existing serving beam received through the existing serving BWPs.

According to exemplary embodiments of a method and apparatus for radio resource operation in the NTN, a terminal connected to the NTN may change its BWP configuration based on BWP configuration change information received from a network entity, such as a satellite. The BWP configuration change information may include frequency change information and/or polarization change information. Therefore, even when the value of the Frequency Reuse Factor (FRF) or the Frequency Reuse/Polarization Factor (FRPF), defined based on the FRF and the number of applicable polarization types, exceeds 1, beam switching can be accomplished with low signaling complexity.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments of the present disclosure, a programmable logic device such as a field-programmable gate array may be used to perform some or all of functions of the methods described herein. In some exemplary embodiments of the present disclosure, the field-programmable gate array may be operated with a microprocessor to perform one of the methods described herein. In general, the methods are preferably performed by a certain hardware device.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An operation method of a first communication node, the operation method comprising:
performing communication with a second communication node using a first beam among multiple beams formed by the second communication node, based on one or more first bandwidth parts (BWPs) allocated by the second communication node and a first polarization;
generating a measurement report including at least a measurement value for the first beam;
transmitting the generated measurement report to the second communication node;
receiving, from the second communication node, BWP configuration change information generated based on a beam switching decision performed at the second communication node based on the measurement report; and
performing communication with the second communication node using a second beam among the multiple beams, based on information on one or more second BWPs and a second polarization identified based on the BWP configuration change information,
wherein frequency-domain positions of paired BWPs of each BWP pair between the one or more first BWPs and the one or more second BWPs have a difference of Δf, and the Δf is a real number identified based on the BWP configuration change information.

2. The operation method of claim 1, wherein a first resource configuration is applied to the first beam, a second resource configuration different from the first resource configuration is applied to the second beam, and each of the first and second resource configurations is defined based on information on a frequency bandwidth available for an applicable beam to which each of the first and second resource configurations is applied and information on a polarization applied to the applicable beam.

3. The operation method of claim 2, wherein one of the first to N-th resource configurations is applied to each of the multiple beams, the first to N-th resource configurations are different from each other, and N is a natural number determined based on a number of types of polarizations applicable to the multiple beams, including the first and second polarizations.

4. The operation method of claim 2, wherein the first resource configuration corresponds to a first frequency bandwidth and the first polarization, the second resource configuration corresponds to a second frequency bandwidth and the second polarization, and frequency-domain positions of the first frequency bandwidth and the second frequency bandwidth have a difference equal to the Δf.

5. The operation method of claim 2, wherein when the first frequency bandwidth corresponding to the first resource configuration and the second frequency bandwidth corresponding to the second resource configuration are equal, and frequency-domain positions of paired BWPs of each BWP pair between the one or more first BWPs and the one or more second BWPs are identical.

6. The operation method of claim 1, wherein the BWP configuration change information includes a polarization change indicator determined based on information on the second polarization.

7. The operation method of claim 6, wherein the polarization change indicator indicates whether to change polarization and is determined based on comparison between the first polarization and the second polarization.

8. An operation method of a first communication node, the operation method comprising:
performing communication with a second communication node using a first beam among multiple beams formed by the first communication node, based on one or more first bandwidth parts (BWPs) allocated to the second communication node and a first polarization;
receiving a measurement report from the second communication node including at least a measurement value for the first beam;
in response to determining beam switching from the first beam to a second beam among the multiple beams based on the measurement report, generating BWP configuration change information including information related to one or more second BWPs corresponding to the second beam and a second polarization;
transmitting the BWP configuration change information to the second communication node; and
performing communication with the second communication node using the second beam, based on the one or more second BWPs and the second polarization,
wherein frequency-domain positions of paired BWPs of each BWP pair between the one or more first BWPs and the one or more second BWPs have a difference of Δf, and the Δf is a real number identified based on the BWP configuration change information.

9. The operation method of claim 8, wherein a first resource configuration is applied to the first beam, a second resource configuration different from the first resource configuration is applied to the second beam, and each of the first and second resource configurations is defined based on information on a frequency bandwidth available for an applicable beam to which each of the first and second resource configurations is applied and information on a polarization applied to the applicable beam.

10. The operation method of claim 9, wherein the first resource configuration corresponds to a first frequency bandwidth and the first polarization, the second resource configuration corresponds to a second frequency bandwidth and the second polarization, and frequency-domain positions of the first frequency bandwidth and the second frequency bandwidth have a difference equal to the Δf.

11. The operation method of claim 8, wherein the BWP configuration change information includes a polarization change indicator determined based on information on the second polarization.

12. The operation method of claim 11, wherein the polarization change indicator indicates whether to change polarization and is determined based on comparison between the first polarization and the second polarization.

13. A first communication node comprising:
a processor, wherein the processor causes the first communication node to perform:
performing communication with a second communication node using a first beam among multiple beams formed by the second communication node, based on one or more first bandwidth parts (BWPs) allocated by the second communication node and a first polarization;
generating a measurement report including at least a measurement value for the first beam;
transmitting the generated measurement report to the second communication node;
receiving, from the second communication node, BWP configuration change information generated based on a beam switching decision performed at the second communication node based on the measurement report; and
performing communication with the second communication node using a second beam among the multiple beams, based on information on one or more second BWPs and a second polarization identified based on the BWP configuration change information,
wherein frequency-domain positions of paired BWPs of each BWP pair between the one or more first BWPs and the one or more second BWPs have a difference of Δf, and the Δf is a real number identified based on the BWP configuration change information.

14. The first communication node of claim 13, wherein a first resource configuration is applied to the first beam, a second resource configuration different from the first resource configuration is applied to the second beam, and each of the first and second resource configurations is defined based on information on a frequency bandwidth available for an applicable beam to which each of the first and second resource configurations is applied and information on a polarization applied to the applicable beam.

15. The first communication node of claim 14, wherein one of the first to N-th resource configurations is applied to each of the multiple beams, the first to N-th resource configurations are different from each other, and N is a natural number determined based on a value of a frequency reuse factor (FRF).

16. The first communication node of claim 14, wherein the first resource configuration corresponds to a first frequency bandwidth and the first polarization, the second resource configuration corresponds to a second frequency bandwidth and the second polarization, and frequency-domain positions of the first frequency bandwidth and the second frequency bandwidth have a difference equal to the Δf.
